(19) United States
(12) Patent Application Publication
(10) Pub. No.: US 2025/0131334 A1
(43) Pub. Date: Apr. 24, 2025

(54) MACHINE LEARNING FOR MODELING PREFERENCE DATA TO OPTIMIZE INTERACTIONS WITH CANDIDATE PARTNERS

(71) Applicant: SENSTASY, INC, LEXINGTON, MI (US)

(72) Inventors: Brian S. Boyer, NEWARK, CA (US); John To, LEXINGTON, MI (US)

(21) Appl. No.: 18/983,200

(22) Filed: Dec. 16, 2024

Related U.S. Application Data
(63) Continuation-in-part of application No. PCT/US2023/025630, filed on Jun. 16, 2023.
(60) Provisional application No. 63/353,012, filed on Jun. 16, 2022.
(60) Provisional application No. 63/404,477, filed on Sep. 7, 2022.

(51) Int. Cl. G06N 20/00; G06Q 30/0251

(52) U.S. Cl. CPC G06N 20/00; G06Q 30/0261

(57) ABSTRACT

Technologies are provided for optimizing candidate partners for a user interaction. The technologies can facilitate a trust in facts and identify mutual interest. The technologies can identify the location of users, share personalized information, provide tools for matching users to candidates, exchange data, advertise to users with tracking algorithms, create avatars, host digital interactions between users, and provide user assessments of other users. Nodes of users, and information on user behavior patterns can help identify matches. Users can share their current moods to communicate with other users. Machine learning is included for modeling a user's own feedback from actual interactions in a pool of candidates. The input to the model includes sets of interaction data on users, and the output from the model is an improved, modeled set of user preferences to improve the user's candidate pool. Images of virtual candidates can be created at each iteration of the model.

### CROSS-REFERENCE TO RELATED APPLICATIONS

This application is a “bypass” application under 35 USC 111(a), a continuation-in-part of International Application No. PCT/US2023/025630, filed Jun. 16, 2023, which claims priority to U.S. Provisional Application No. 63/353,012, filed Jun. 16, 2022, and U.S. Provisional Application No. 63/404,477, filed Sep. 7, 2022, each of which is incorporated by reference herein in it's entirety.

### BACKGROUND

### Field of the Invention

The teachings herein are directed to methods of confirming a mutual interest between persons, and systems for performing those methods.

### Description of the Related Art

Sometimes people can be interested in each other but never make a connection, because they don't know there is a mutual interest and, perhaps, even a romantic attraction. Perhaps the connection doesn't occur simply because the mutual interest is unknown or, sometimes, because there is a fear of rejection. The art would appreciate having a tool that could help optimize a list of candidate partners, as well as a tool that could help ensure there is a mutual interest in an interaction, as well as a measured basis for such a mutual interest.

A lot of money, time, and emotion can be invested, and lost, in choosing a less than optimal match between people, whether for love, friendship, business, or any goal that requires “getting along” and, perhaps, even creating a synergy in the relationship. A problem with existing matching processes is that the people being matched have too much control, if not all of the control, over the selection process, and the process seems to focus on a one-sided perception of interest. Machine learning models can help facilitate a process of finding a match between people by modeling actual interactions between people and providing new perspectives on what appears to be important to a user of the process, perspectives that arrive outside of the user's preconceived preferences, in achieving the most positive interaction outcomes for the user.

Situations in which mutual interest can play a part can include business relationships, potential friendships and, perhaps, even romantic relationships. The dating market, for example, is very larger, TINDER having over 530 million users, BADOO having over 318 million users, PLENTY OF FISH having over 150 million users, BUMBLE having over 100 million users, MATCH having over 96 million users, ASHLEY MADISON having over 70 million users, HAPPN having over 100 million users, ZOOSK having over 40 million users, ADULT FRIEND FINDER having over 99 million users, EHARMONY having over 37 million users, OKCUPID having over 30 million users, OURTIME having over 8.9 million users, ELITESINGLES having over 13 million users, SILVER SINGLES having over 800,000. And, there are several more. Each one of these services, however, includes a certain amount of trust in the other party before meeting them, including trust that the information they're providing about themselves is, in fact, true. Perhaps their stated appearance is not true, perhaps their stated age is not true, perhaps their knowledge or experience in a certain area is not true, perhaps their likes and dislikes are not true, perhaps they're not friendly, they're actually threatening or dangerous, and so on. And, users of these systems do not (i) identify mutual interests; (ii) use machine learning technology to inputs sets of their own feedback from actual interactions in a pool of candidates created from their perceived preferences to improve their pool of candidates and likelihood of success in future interactions.

Anyone looking for a relationship in a matching system should appreciate having a method or system that can address the issues described above. Having a way to confirm alleged candidate attributes can be helpful, and identifying a mutual interest before reaching out to make a connection can also be helpful. The art will appreciate having systems and methods that (i) identify mutual interests; and (ii) use machine learning technology to improve candidate pools for users, helping to ensure a likelihood of success in future interactions. It will be appreciated that training data sets from a user's own feedback from actual interactions in a pool of candidates are used as input to train and test the machine learning model, and the output is a modeled set of preferences that can be used iteratively to improve the user's pool of candidates for interactions.

### SUMMARY

Systems and methods are provided to assist in making a mutual connection based on, for example, user preferences modified by interaction data, trusted facts and an identification of a mutual interest. Machine learning can be used for modeling a user's own feedback from actual interactions in a pool of candidates, and this can generate modeled preferences to create an improved candidate pool for the user. The input to the model includes sets of interaction data on users, and the output from the model is an improved, modeled set of user preferences to improve selections for the user's candidate pool. In some embodiments, images of virtual candidates can be created, even at each iteration of the model.

A machine learning method of modeling preference data to optimize candidate partners of interest for a user interaction is provided in some embodiments. The method can include gathering initial preference data from a user of a networking community. It should be appreciated that the preference data can be any data that establishes a criteria for the candidate to meet. For example, “preference data”, in some embodiments, can include any trait that the user may want to find in a candidate partner, for example, sexual preference, political preference, religious preference, social tolerances, appearance, age, health, temperament, income, profession, intelligence, humor, parenting practices, hobbies, activity level, personal goals, expectations of a partner, and the like. The method can include assembling a pool of candidate partners for the user from within the matching network based on the initial preference data from the user, each candidate in the pool meeting the set of criteria within an acceptable deviation threshold used by the method to select each candidate in the pool.

As the method models preference data from actual interaction data, the method can include obtaining a plurality of sets of interaction data from the user, each set in the plurality of sets representing the user's assessment of an actual interaction with a respective candidate in the initial pool. In order to generate a useful model, the method can include developing a machine learning model with the plurality of sets of interaction data, the machine learning model suitable for accepting the plurality of sets of interaction data from the user as an input and functioning to produce a modeled preference data for the user as an output, the developing including selecting the machine learning model;
preparing the plurality of sets of interaction data for use in training and testing the model, the preparing including splitting the data into training data for training the model, and testing data for testing the model;
training the model with the training data, the training including selecting training variables;
testing the model with the testing data to evaluate the utility of the output;
improving the performance of the machine learning model, the improving including adjusting the variables in the training to improve the output of the model.

The modeled preferences allow for a method that includes creating a modified pool of candidate partners using the output of the model from the input of the plurality of sets of interaction data. In fact, the model can include an iterative approach, for example, modeling preference data for the user using an iterative application of the model that includes repeating the assembling, the providing, the obtaining, the developing, and the creating to optimize the candidate partners for a user interaction.

The number of candidates in a pool can vary, and it may be helpful to the user to rank the candidates. In some embodiments, the method can include providing initial match scores to the user for selecting interactions to pursue, the initial match scores including a numerical assessment that provides a measure-of-fit of each candidate to the set of criteria. The measure-of-fit can be an average of measure of fit to the criteria as a whole, where the criteria is the complete set of preferences. In some embodiments, the preferences can be presented as weighted criteria. And, in some embodiments, the measure-of-fit can be a fit to particular preferences representing criteria that the user may want to compare individually. In some embodiments, the providing of the initial match scores is limited to candidates that meet an acceptable deviation selected by the user.

Since there are at least two parties to an interaction, and both parties should be satisfied in the match, it would be valuable to have a machine learning method of modeling preference data to optimize candidate partners of interest for both users in an interaction to help ensure a mutual interest between users. In these embodiments, the methods can include gathering initial preference data from a first user of a networking community, and gathering initial preference data from a second user of the networking community. Since there are two sets of preference data, the method also functions for assembling a first pool of candidate partners for the first user from within the matching network based on the initial preference data from the first user, each candidate in the first pool meeting the set of criteria within an acceptable deviation threshold used by the method to select each candidate in the first pool; and, assembling a second pool of candidate partners for the second user from within the matching network based on the initial preference data from the second user, each candidate in the second pool meeting the set of criteria within an acceptable deviation threshold used by the method to select each candidate in the second pool.

In order to model inputs that represent each user, the method can include obtaining a plurality of sets of interaction data from the first user, each set in the plurality of sets representing the first user's assessment of an actual interaction with a respective candidate in the initial pool; and, obtaining a plurality of sets of interaction data from the second user, each set in the plurality of sets representing the second user's assessment of an actual interaction with a respective candidate in the initial pool. The data allows for development of a machine learning model. As such, the method can include developing a machine learning model with the plurality of sets of interaction data from the first user as a first input, and the plurality of sets of interaction data from the second user as a second input, the machine learning model suitable for accepting the first input and the second input, and functioning to produce a first modeled preference data for the first user in a first output and a second modeled preference data for the second user in a second output, the developing including
selecting the machine learning model;
preparing the first input and the second input for use in training and testing the model, the preparing including splitting (i) the first input into a first training data and a first testing data; and, (ii) the second input into a second training data and a second testing data;
training the model with the first training data, the training including selecting training variables;
testing the model with the first testing data to evaluate the utility of the output;
training the model with the second training data, the training including selecting training variables;
testing the model with the second testing data to evaluate the utility of the output;
improving the performance of the machine learning model, the improving including adjusting the variables in the training to improve the output of the model;

The modeled preferences allow for a method that includes creating a modified pool of candidate partners for the first user using the output of the model from the plurality of sets of interaction data from the first user; and, creating a modified pool of candidate partners for the second user using the output of the model from the plurality of sets of interaction data from the second user. In fact, the model can include an iterative approach, for example, modeling preference data for the first user using an iterative application of the model that includes repeating the assembling, the providing, the obtaining, the developing, and the creating to optimize the candidate partners for a user interaction for the first user; and, modeling preference data for the second user using an iterative application of the model that includes repeating the assembling, the providing, the obtaining, the developing, and the creating to optimize the candidate partners for a user interaction for the second user; wherein, the candidate partners for the interaction for the first user are modified to exclude the second user when the candidate partners for the second user do not include the first user; and, the candidate partners for the interaction for the second user are modified to exclude the first user when the candidate partners for the first user do not include the second user.

As in the case of the modeling for the one user, the method can be configured for providing initial match scores to the first user and the second user for selecting interactions to pursue, the initial match scores including a numerical assessment that provides a measure-of-fit of each candidate to the set of criteria. In some embodiments, the providing of the initial match scores is limited to candidates that meet an acceptable deviation selected by the user.

In some embodiments, a machine-learning method of optimizing a match for a user of a matching network is provided by comparing a modeled virtual, ideal partner to a candidate partner. The method can include creating an initial virtual, ideal partner, Pvi, for the user of the network based on initial preference data as input obtained from the user. In these embodiments, the creating can include gathering initial preference data from the user of the network, the initial preference data including a set of criteria selected by the user; and, forming a representation of the Pvi for the user of the network based on the initial preference data from the user. It should be appreciated that the virtual image can be output based on any number of factors such as, for example, appearance, age, health, activity level, and the like.

As in other embodiments, the method can include assembling an initial pool of candidate partners for the use from within the matching network based on the initial preference data from the user, each candidate in the initial pool meeting the set of criteria within an acceptable deviation threshold used by the method to select each candidate in the initial pool.

These embodiments can also include providing initial match scores to the user for selecting interactions to pursue, the initial match scores including a numerical assessment that measures the fit of each candidate to the set of criteria. In some embodiments, the providing of the initial match scores is limited to candidates that meet an acceptable deviation selected by the user.

In order to train and test the machine learning model, the method can include obtaining a plurality of sets of interaction data from the user, each set in the plurality of sets representing the user's assessment of an actual interaction with a respective candidate in the initial pool. As such, the method can include developing a machine learning model with the plurality of sets of interaction data, the machine learning model suitable for accepting the plurality of sets of interaction data from the user as an input and functioning to produce a modeled preference data for the user as an output, the developing including
selecting the machine learning model;
preparing the plurality of sets of interaction data for use in training the model, the preparing including splitting the data into training data for training the model, and testing data for testing the model;
training the model with the training data, the developing including selecting training variables;
testing the model with the testing data to evaluate the utility of the output; and,
improving the performance of the machine learning model, the improving including adjusting the variables in the training process to improve the output of the model.

In order to use the model to general modeled preferences that improve the candidate pool, the method can include iterating the model stepwise from Pvi to a modeled, virtual ideal partner, Pvmn, where n ranges from 1 to T, and T is the total number of iterations of the model, the modifying including creating each Pvmn from modeled preference data output by the model at each iteration.

Once the modeled preference data is generated at each iteration, the method can include modifying the pool of candidate partners at each iteration using the modeled preference data for each Pvmn.

After the user is satisfied with the candidate pool, or the system has reached a convergence that results no further improvements, the method can include forming a representation of PvmT for the user of the network based on the modeled preference data from the user.

In some embodiments, the representation of Pvi is a data representation. In some embodiments, the representation of Pvi is a graphical representation that includes an image of Pvi. In some embodiments, the representation of PvmT is a data representation. In some embodiments, the representation of PvmT is a graphical representation that includes an image of PvmT. In some embodiments, the method includes forming a representation of each Pvmn for the user of the network at each iteration, the representation including an image of each Pvmn.

Since the methods require a system to implement them, a machine learning system is also provided for modeling preference data to optimize candidate partners of interest for a user interaction. These systems comprise a processor and a memory. The memory can include a preference module on a non-transitory computer readable medium operable for receiving and storing initial preference data from a user of a networking community; a pooling module on a non-transitory computer readable medium operable for assembling a pool of candidate partners for the user from within the matching network based on the initial preference data from the user, each candidate in the pool meeting the set of criteria within an acceptable deviation threshold used by the method to select each candidate in the pool; an interaction database on a non-transitory computer readable medium operable for receiving and storing a plurality of sets of interaction data from the user, each set in the plurality of sets representing the user's assessment of an actual interaction with a respective candidate in the initial pool; a modeling engine on a non-transitory computer readable medium operable for developing a machine learning model with the plurality of sets of interaction data, the machine learning model suitable for accepting the plurality of sets of interaction data from the user as an input and functioning to produce a modeled preference data for the user as an output.

In these embodiments, the developing can include
selecting the machine learning model;
preparing the plurality of sets of interaction data for use in training and testing the model, the preparing including splitting the data into training data for training the model, and testing data for testing the model;
training the model with the training data, the training including selecting training variables;
testing the model with the testing data to evaluate the utility of the output; and, improving the performance of the machine learning model, the improving including adjusting the variables in the training to improve the output of the model.

Consistent with their counterpart methods, the systems can be configured for
creating a modified pool of candidate partners using the output of the model from the input of the plurality of sets of interaction data;
sending the modified pool of candidate partners to the pooling module for use in a next iteration of the system; and,
generating a modeled preference data for the user through the iterative application of the model to optimize the candidate partners for a user interaction.

In some embodiments, the modeling engine trains and tests the model using interaction data from a plurality of users and a respective plurality of sets of interaction data from the plurality of users.

In some embodiments, the pooling module is configured to
exclude the second user from the candidate pool of the first user when the candidate partners for the second user do not include the first user; and,
exclude the first user from the candidate pool of the second user when the candidate partners for the first user do not include the second user.

In some embodiments, the systems further include an assessment module on a non-transitory computer readable medium operable for providing initial match scores to the user for selecting interactions to pursue, the initial match scores including a numerical assessment that provides a measure-of-fit of each candidate to the set of criteria.

In some embodiments, the systems further include a representation module on a non-transitory computer readable medium operable for creating an initial virtual, ideal partner, Pvi, for the user of the network based on initial preference data as input obtained from the user, the creating including
gathering initial preference data from the user of the network, the initial preference data including a set of criteria selected by the user; and,
forming a representation of the Pvi for the user of the network based on the initial preference data from the user.

In some embodiments, the representation module is configured for forming an image of the Pvi for the user based on the initial preference data. In some embodiments, the representation module is configured for forming an image of the Pvi for the user based on the initial preference data. In some embodiments, the representation module is configured for forming an image of the Pvmn, where n ranges from 1 to T, and T is the total number of iterations of the model, the modifying including creating each Pvmn from modeled preference data output by the model at each iteration. In some embodiments, the representation module is configured for forming an image of PvmT.

In some embodiments, the systems can include a system for identifying a mutual interest between a first user and a second user within a shared user environment. In these embodiments, the system can comprise a processor; and, a memory on a non-transitory computer readable medium. The memory can include a registration module on a non-transitory computer readable medium, the registration module operable for receiving user information and assigning a first anonymous identifier to the first user and a second anonymous identifier to the second user for use in the shared user environment; a location engine on a non-transitory computer readable medium, the location engine operable for identifying the location of the first user and the location of the second user within the shared user environment; an assessment module on a non-transitory computer readable medium, the assessment module operable for the first user to identify and assess the second user, and the second user to identify and assess the first user; a matching module on a non-transitory computer readable medium, the matching module operable for the first user to identify a match with the second user and the second user to identify the match with the first user, the matching module notifying the first user and the second user of the match; a data exchange module on a non-transitory computer readable medium, the data exchange module operable for the first user to communicate with the second user upon the identification of the match, and the second user to communicate with the first user upon the identification of the match; and, a shared user database on a non-transitory computer readable medium, the shared user database operable for storing personal information, location information, and the anonymous identifiers of n users, in which n is a number of users ranging from 2 users to any number of users, of which at least the first user and the second user are in the shared user environment. In such embodiments, each of the first user and the second user are notified of the match by the matching module and have the option to communicate with the other user through the data exchange module.

Likewise, methods for a second user to identify a mutual interest with a first user within a shared user environment using the systems are provided. The methods can include using the systems taught herein, which can include registering as the second user in the shared user database through the registration module and obtaining the second anonymous identifier as a persona in the shared user environment; entering the shared user environment and allowing the location engine to establish a second location of the second anonymous identifier in the shared user environment, the location of the second identifier accessible by the n users in the shared user environment; identifying the first user in the shared user environment with the assessment module by identifying a first location of the first anonymous identifier through the location module; assessing the first user with the assessment module; receiving the notice of the match with the second user from the matching module; and, choosing whether to communicate with the second user through the data exchange module. And, as noted, each of the first user and the second user are notified of the match by the matching module and have the option to communicate with each other through the data exchange module.

In some embodiments, both the systems and methods can include an advertising module, the advertising module instructing the processor to identify particular user location data and activity tracking data, and to target advertising to those particular users.

In some embodiments, both the systems and methods can include a feedback module, the feedback module instructing the processor to receive and record feedback by one or more users of the system.

In some embodiments, both the systems and methods can include an avatar module, the avatar module instructing the processor to create avatars designed or selected by users of the system.

In some embodiments, both the systems and methods can include a conferencing module, the conferencing module instructing the processor to hold conferences between users of the system.

In some embodiments, both the systems and methods can include a ratings module, the ratings module instructing the processor to measure or assess relative levels of interest in other users.

In some embodiments, both the systems and methods can include a governing module, the governing module instructing the processor to set a governing level of interest in a user's database before the system recognizes a mutual interest in a meeting.

In some embodiments, both the systems and methods can include a distribution module, the distribution module instructing the processor to help users locate nodes of users of the system.

In some embodiments, both the systems and methods can include an intelligence module, the intelligence module instructing the processor to target and compile the select logistics of users of the system.

In some embodiments, both the systems and methods can include a mood module, the mood module instructing the processor to show the mood of one or more users of the system to other users of the system.

One of skill will appreciate that the systems and methods used herein can use any combination of modules taught herein.

The following embodiments can operate independently, or in combination with, any of the above embodiments:

### BRIEF DESCRIPTION OF THE FIGURES

FIG. 1 illustrates a location screen provided by the location engine for a first user, the identifier showing several anonymous registered users, according to some embodiments.

FIG. 2 illustrates a location screen provided by the location engine for a second user, the identifier showing several anonymous registered users, according to some embodiments.

FIG. 3 illustrates a match screen from the matching module that provides the option to communicate through the data exchange module, according to some embodiments.

FIGS. 4A-4D show how a user can measure interests in other users of the network, according to some embodiments.

FIGS. 5A and 5B illustrate node distributions that are identified by geographical location, time of day, and population density, according to some embodiments.

FIG. 6 illustrates processor-memory configurations for systems taught herein, the memory having an engine and modules that instruct the processor to perform tasks, according to some embodiments.

FIG. 7 illustrates how the processor and memory can fit within a computer system having system inputs and system outputs, input devices, output devices, according to some embodiments.

FIG. 8 illustrates how a network can be used for the methods and systems taught herein, according to some embodiments.

FIG. 9 illustrates a machine learning system, according to some embodiments.

FIGS. 10A-10C illustrate avatar types, according to some embodiments.

### DETAILED DESCRIPTION

Systems and methods are provided to assist in making a mutual connection, based on trusted facts and an identification of a mutual interest. The systems can include a system for identifying a mutual interest between a first user and a second user within a shared user environment. The system can comprise a processor; and, a memory on a non-transitory computer readable medium having instructions for execution by the processor.

The memory can include a registration module on a non-transitory computer readable medium, for example, the registration module operable for receiving user information and assigning a first anonymous identifier to the first user and a second anonymous identifier to the second user for use in the shared user environment. The memory can also include a location engine on a non-transitory computer readable medium, the location engine operable for identifying the location of the first user and the location of the second user within the shared user environment. An assessment module on a non-transitory computer readable medium can be included, in some embodiments, the assessment module operable for the first user to identify and assess the second user, and the second user to identify and assess the first user. Many embodiments will include a matching module on a non-transitory computer readable medium, the matching module operable for the first user to identify a match with the second user and the second user to identify the match with the first user, the matching module notifying the first user and the second user of the match.

And, for the matched parties to communicate, a data exchange module on a non-transitory computer readable medium can be included, the data exchange module operable for the first user to communicate with the second user upon the identification of the match, and the second user to communicate with the first user upon the identification of the match. And, since the shared user network can host a large number of shared user environments at any given time, and the user's are registered as members of the network, a shared user database on a non-transitory computer readable medium can be included to store information about the registered users. In some embodiments, the shared user database can be operable for storing personal information, location information, and the anonymous identifiers of n users, in which n is a number of users ranging from 2 users to any number of users, of which at least the first user and the second user are in the shared user environment. In such embodiments, each of the first user and the second user are notified of the match by the matching module and have the option to communicate with the other user through the data exchange module.

Likewise, methods for a second user to identify a mutual interest with a first user within a shared user environment using the systems are provided. Any number of users can be in the shared user network, the shared user network having any number of shared user environments at any point in time. In some embodiments, a method of identifying a mutual interest can include using the systems taught herein. In some embodiments, the using of the systems can include registering as the second user in the shared user database through the registration module and obtaining the second anonymous identifier as a persona in the shared user environment. Once registered, the using can include entering the shared user environment and allowing the location engine to establish a second location of the second anonymous identifier in the shared user environment.

It should be appreciated that the systems can have n users in the shared user network, and n can be any number of users. Likewise, a shared user environment with the shared user network can also have n users, any number of users. In some embodiments, the location of the second identifier can be accessible by the n users in the shared user environment.

The methods can include identifying the first user in the shared user environment with the assessment module by identifying a first location of the first anonymous identifier through the location module. Since the second user needs to indicate interest, the method can include assessing the first user with the assessment module.

The systems are configured to identify users having a mutual interest in each other, and so the system can include notifying the first user of the match, the first user receiving the notice of the match with the second user from the matching module. And, since an objective of the systems and methods is to match users that share a mutual interest in each other, the systems can allow matched users to choose whether to communicate with each other through the data exchange module. For example, when notified of the match with the second user, the first user can choose whether to respond at all, how to respond, and whether to start communications with the second user. As noted, a desired feature in many embodiments is that each of the first user and the second user are notified of the match by the matching module and have the option to communicate with each other through the data exchange module.

In some embodiments, an application or feature can be referred to as Sensetasy™ and can function through interaction with a mobile device, such as a smartphone, tablet, laptop. In some embodiments, such an application or feature can function through a desktop or other computing devices. Having the ability to identify a mutual interest with another allows for a notification of that interest for a match to connect, and to connect anonymously in some embodiments. A feature of embodiments taught herein is that the chances of rejection and/or embarrassment are reduced or eliminated, which may help those who may be too shy, frightened, or otherwise hesitant to take the initiative for communication.

In some embodiments, upon notification of a match, the user has the option to continue to communicate (chat, email, call) anonymously to get to know each other more or to verify legitimacy of mutual attraction or the user also has option to reveal identity. These embodiments can help to minimize false matches or scams, as only when both parties opt in to reveal identity, can both parties see each other's identity.

As an illustrative example, a plurality of users can register on a shared user network, which includes storing the data on a shared user database on a non-transitory computer readable medium. A first registered user is “James” (user A) and a second registered user is “Michelle” (user B).

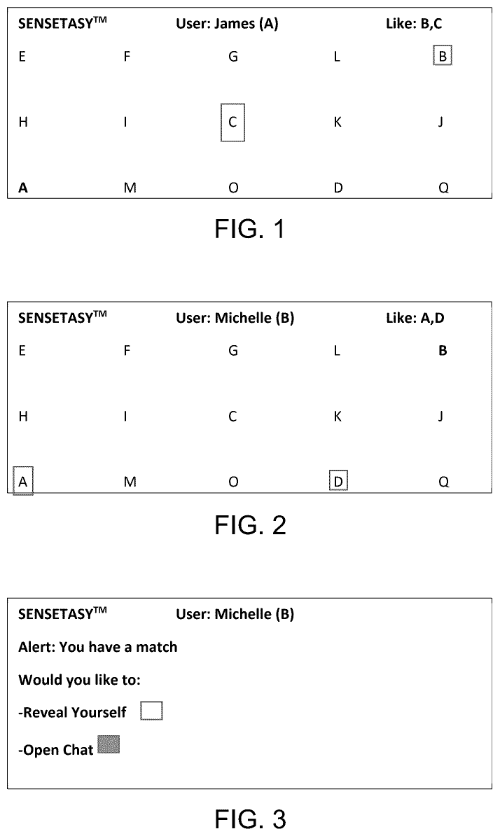

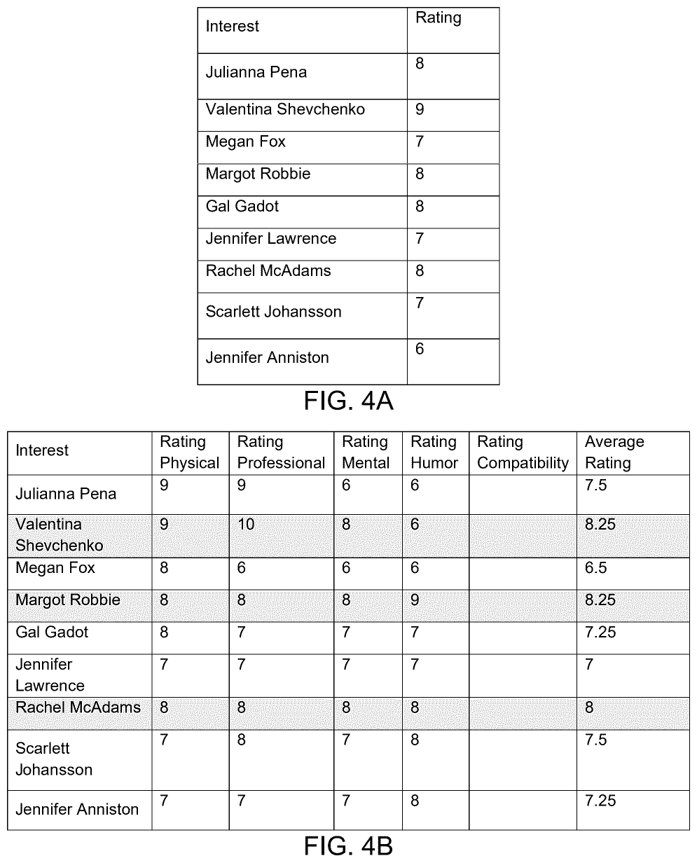

Both James and Michelle can remain anonymous in the shared user network, and can be represented anonymously by the nodes “A” and “B” shown in FIGS. 1 and 2. In some embodiments, the system can include a map that tracks the locations of all users in the shared user network. And, in some embodiments, the location is tracked in real time.

The locations can be tracked using any known technology, such as satellite tracking through GPS, cell phone data, BLUETOOTH, and the like. In some embodiments, the tracking can be turned on and off by the user. In some embodiments, the map may have the layout of the locality or shared user environment, and this can be done using stored maps of record, or perhaps it can be accomplished using crowd source data, satellite images or local maps. A “local map” of a shared user environment might be a map of a resort, a neighborhood, a school, a cruise ship, and shopping mall, and the like.

In some embodiments, the shared user environment can be any social event, such as a pool party, a wine tasting, a first day in class, a fundraiser banquet, or the like. For example, perhaps the shared user event is James and Michelle's first day in class in college. James and Michelle decide to look for matches on their mobile devices and turn on their location tracking. Several registered users are anonymously identified through location tracking.

FIG. 1 illustrates a location screen provided by the location engine for a first user, the identifier showing several anonymous registered users, according to some embodiments. James sees two girls that he finds attractive, assessed using characteristics such as appearance, expressions, and communication. The girls are represented by nodes B and C. Node B is located in the front right corner of the room and node C is in the center of the room. James has identified users of interest by location through the location engine and can now assess them and enter his assessments in the shared user network through the assessment module, so that the matching module can identify either or both of the two girls should there be a match.

FIG. 2 illustrates a location screen provided by the location engine for a second user, the identifier showing several anonymous registered users, according to some embodiments. Michelle happen to be attracted to two guys represented by nodes A and D. Michelle is node B and she sits at front right corner of the class. James is node A and he sits at back left corner of the class. The matching module can now compare James' assessments to Michelle's assessments and notify both James and Michelle of the match. Since neither James nor Michelle know the identification of the other, the notifications remain anonymous.

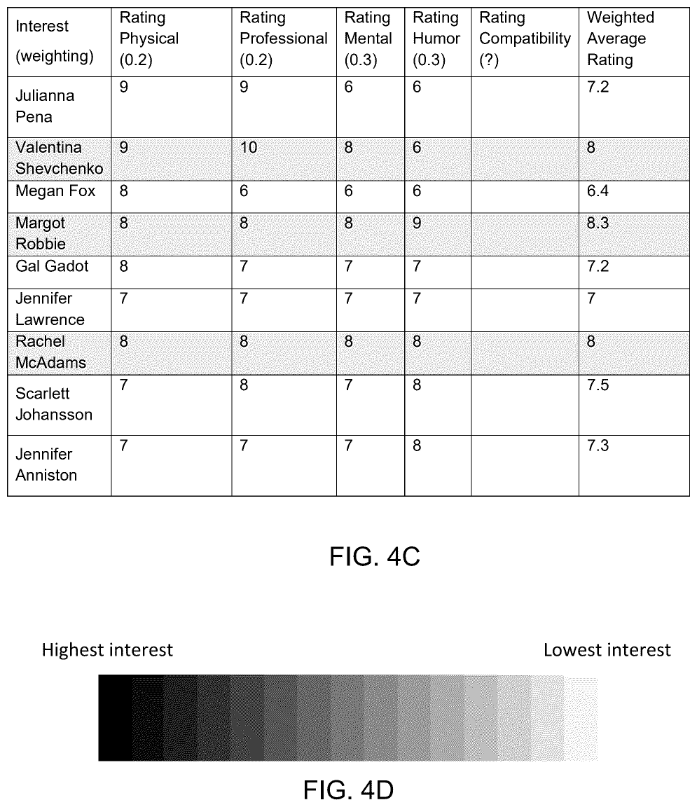

FIG. 3 illustrates a match screen from the matching module that provides the option to communicate through the data exchange module, according to some embodiments. Since there is a mutual match of nodes A and B, James and Michelle gets a notice that there is a match and can now choose whether to communicate and how to communicate.

In some embodiments, upon a match notification, users can decide to chat anonymously. In some embodiments, upon a match notification, users can decide to reveal themselves. Such options allow the users to meet at their own pace, decide whether there is an interest beyond first impressions, and further assess the match on their own based on a multitude of factors that make communications complex and interesting. Perhaps they prefer to have more time to test the other user's personality on an anonymous chat. Perhaps they prefer to directly observe the other user's personality and responses in real life circumstances immediately. Perhaps they just want to take it slow in an anonymous chat, reveal themselves for a chat while sharing identities, and then test out a real life interaction in person. In FIG. 3, Michelle decided she would like an open chat and, if James opts for the same, the data exchange module will open that channel of communication to them. If both chose to reveal themselves, the data exchange module would also remove the anonymity and provide sufficient data for them to identify each other.

It should be appreciated that it may be difficult at times to determine location with sufficient accuracy. In some embodiments, a user may manually sketch the layout of the locality and manually place their location on the location screen in the shared user environment. For example, if the app shows James that he's incorrectly placed in the middle of the room when he knows he's actually in the left back corner, he can correct the application to move his node to that corner of the room. In some embodiments, if the shape of the room isn't shown accurately, a user can manually reshape the room to better place his location. Such embodiments can be useful if the room does not allow for good cell or satellite signals, and a crowdsourcing of such manual mapping of locations by the users in the shared user environment can be integrated by the location engine to increase the accuracy of the location map provided by the location engine. In some embodiments, the users of the shared user environment can share location data onsite at the shared user environment. For example, users can opt to share this data through Bluetooth communications. User A can get Bluetooth signals from user B, C, and D and integrate the data on user A's map, and each of user's B, C, and D can share in the data in the same way.

Any environment can serve as a shared user environment. In some embodiments, the system can work in a dynamic motion setting as well such as a park. In such embodiments, a group of people may be walking in the park, for example, the group having registered users of the system. In such embodiments, any manner of identifying the registered users may be implemented. For example, color can be used to separate men from women where, perhaps, men can be represented in blue letters and women can be represented in pink letters. Michelle sees 2 men she likes: A in front of her and D to the right of her at what may be referred to as her “3 o'clock” position. Michelle can click on those. James happens to be at her 3 o'clock position. James likes woman B to his left at his “9 o'clock” position, and woman C to his right at his 3 o'clock position. So, James clicks on B and C. Due to this relative positioning through the location engine, the system finds the match with the matching module and notifies for Michelle and James of the match.

In some embodiments, there can be a time lapse in assessing registered users at shared user environments for matches. For example, Michelle noticed A and clicked on Saturday. James noticed B and click on B on Sunday. The match alert still notifies James and Michelle.

It should be appreciated that the systems and methods taught herein extend beyond romantic matching. In some embodiments, the systems and methods help match potential friends or potential business partners.

In some embodiments, users can use the registration module to choose which personal attributes to include in their user profile, as well as which of those personal attributes to reveal for their node in the shared user environment. For example, a user may choose to reveal hair color, hair style, height, skin tone, or race. In some embodiments, this may improve node identification accuracy, or the ability to locate the user in a shared user environment.

The systems and methods can function to host advertising in some embodiments. All advertising functions can be configured on an advertising module on a non-transitory computer readable medium, in some embodiments. User location data and activity tracking data can be used to target advertising to particular users, for example. In some embodiments, the user can use the advertising module to opt-in to, or opt-out of, such advertising. Opting-in can reduce or eliminate the user's costs of participating in the system, in some embodiments.

The systems and methods can function to allow for users to give and/or receive feedback on a feedback module on a non-transitory computer readable medium. The feedback can be on themselves or anybody that they interact with through the system. In some embodiments, it is optional to give and/or receive or view feedback. In some embodiments, the system can flag the feedback as positive or negative, and the flagging can be used by the user to label and choose the type of feedback they prefer to see. In some embodiments, the feedback can be anonymous. In some embodiments, the feedback can be selectively public, chosen by the recipient of the feedback for display to the network. In some embodiments, the feedback can be deleted by the provider, the recipient, or both.

For example, perhaps James and Michelle went on a date and it didn't work out. Both James and Michelle can provide feedback on the feedback module. In some embodiments, the feedback is immediately available. In some embodiments, the feedback is not available until they go on other dates. James discovers, to his surprise, that all of his dates feel his is charming while sober but annoying after he's been drinking. James finds this useful, and controls or stops drinking around women he is dating.

Feedback may also be useful in the business setting. For example, an executive may not realize how often he says “again” or “obviously”, for no reason, during his speeches. He may get that feedback from registered user that helps him in his presentations.

Professional or peer-to-peer coaches can also sign up to coach to improve the participant. Feedback can be useful, in these embodiments, as it gives the coach a measure of the positive traits to reinforce and the negative traits to address. Patterns of negative feedback can be used to connect to a coach specializing in that area.

In many embodiments, the shared user environment is the real physical world. However, in some embodiments, interactions can occur in the virtual world. In some embodiments, the virtual world can include OCULUS environments, video game environments. In some embodiments, users can interact in a metaverse. In some embodiments, users can interact using avatars, and the avatars can be designed to simulate their actual size, shape, weight, age, skin color, hair color, hair style, or any combination thereof. For example, in some embodiments, users can have avatars of themselves constructed from pictures of themselves. In some embodiments, a 3D representation can be sourced from 3D scanner or construction from taking pictures of the subject at different angles. In some embodiments, the system can build a 3D avatar from multi-angle pictures of the subject. In such embodiments, the systems can include an avatar module on a non-transitory computer readable medium.

The systems and methods taught herein can be applied as follows:

### Entering User Ratings Through a Ratings Module.

It should be appreciated that each user will have varying levels of interest in other users, and this relative level of interest can change as users get to know each other over time. One of skill will appreciate having a ratings module on a non-transitory computer readable medium that instructs the processor to measure and/or assess relative levels of interest in other users. In some embodiments, the ratings module allows users to look at ratings about themselves from other users. Ratings can be simple, as a single measure, or complex with any number of measures, and the measures can be weighted in some embodiments. Likewise, ratings can be editable, or they can be locked, and ratings can be accumulated over time to measure change in ratings over time.

Since we're talking about assessing mutual interests, the interests can be measured, and can change from the vantage point of each of users. The fact that there's a “mutual interest” certainly doesn't mean that there's always the same level of interest between people, and it doesn't mean that the levels of interest cannot be dynamic, fluctuating between users of the system.

As such, the systems and methods provided herein can have a ratings module, a mechanism that allows each user of the system to enter, or calculate, a relative rating that can be used as a way to measure and rank interests in other users of the system. In some embodiments, the ratings module can allow a user to select personal attributes subjectively from a list of potential attributes of interest. Such potential attributes of interest may include, for example, physical appearance, professional skills or accomplishments, mental qualities, humor, compatibility, income, age, height, weight, athleticism, ethnicity, style, taste, integrity, energy, courage, location, material possessions, frugality, hobbies, IQ, political party, ambitions, and the like, or any combination thereof. In some embodiments, the personal attributes can be grouped into sets for easy selection, the groups arranged according to the meeting of interest, where a romantic interest would have a different selection of attributes than a platonic interest, a business interest, or a professional interest, for example.

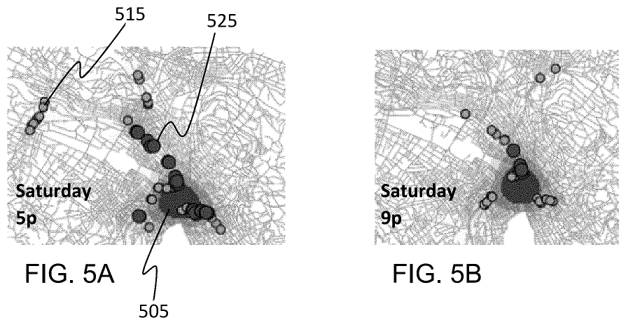

FIGS. 4A-4D show how a user can measure interests in other users of the network, according to some embodiments. FIG. 4A shows a simple rating that, perhaps, may be based on a scale from 1 to 10, where 1 is the lowest interest and 10 is highest interest, which is nice because it is an easy way to quickly rate other users. FIG. 4B shows a categorized, average rating in which each of the categories are weighted the same, which allows the users of the system to categorize how they rate other users. In FIG. 4B, the user did not provide a compatibility rating on this pass, as the user has not yet met the other users of interest. The average rating can be updated after meeting other users, for example, and entering relative measures of compatibility.

A user can get a better rating with such a system by providing a more personalize weighting to each of the categories to provide a more useful weighted average. For example, the user could use a simple weighted formula, such as the following:

$$Rating of {C}_{i} = \sum {X}_{n} {T}_{n} ;$$

wherein,
Cᵢ is the candidate of interest, where i can be an integer ranging from 1 to z, where z is the number of candidates;
Tₙ is a personal trait, where n is an integer that is used to identify that personal trait, n ranging from 1 to the number of personal traits selected by the user in calculating a weighted average rating for Cᵢ the candidate of interest; and,
Xₙ is the fractional weighting for it's respective personal trait Tₙ, where ΣXₙ=1.

With respect to FIG. 4B, for example, the formula may be the following:
C₁=X₁T₁+X₂T₂+X₃T₃+X₄T₄+X₅T₅; where T₁ is physical, T₂ is professional, T₃ is mental, T₄ is humor, and T₅ is compatibility which is not addressed; wherein,
C_{Pena}=0.2(9)+0.2(9)+0.3(6)+0.3(6)=7.2, showing that Pena has a lower rating overall when using the weighting factors subjectively chosen by the user of the system. Such a measure can help the user to effectively select better candidates of interest that may better fit a subjective criteria that is designed for the purpose of the relationship.

FIG. 4C illustrates how the weighting used in the Pena case affected the overall ratings when applied to all candidates. Although the 3 top candidates remained the same, there was a clear tie-breaker between the top 2 candidates which could help the user to make a better choice on a selection for first candidate interview.

As such, it is clear that the system can be used to organize an order of priority of interests, and any algorithm known to skill can be used to provide ratings and assess relative ratings, and so the algorithm chosen is not critical, although the accuracy and usefulness of the algorithm can vary by it's content and applicability to a particular environment.

By definition, a “mutual” interest is not a one-sided transaction, which means users would benefit from an opportunity to make such assessments of other users. A first user may rank a second user as a top priority, whereas the second user may rank the first user as, perhaps, fifth in her top ten interests. Both users can prioritize a meeting according to their own priorities, and having a numerical system to help make the assessments of candidates will help each user schedule meetings. In some embodiments, the ratings module can inform each user of a current rating assigned by other users, which is relevant information to use when deciding how to schedule meetings. In one example, a job candidate may rate a first potential employer as a 9 on a scale of 1 to 10, whereas that employer rates the candidate as a 6. The job candidate may rank a second potential employer as an 8.5, whereas that potential employer rates the candidate at a 9. The candidate may feel that the second potential employer is the overall best fit, meeting the candidate's criteria very well while thinking highly of the candidate at the start. Even if the candidate were to become employed with the first potential employer, the risk of failure and loss of employment may be too high relative to any perceived benefits that might seem apparent from the first potential employer. The same reasoning applies to relative fits between possible romantic interests, platonic interests, other types of business relationships including potential investors, partners, contractors, and the like.

The system can be configured with a governing module that instructs the processor to set a governing level of interest in a user's database before the system recognizes a mutual interest in a meeting. For example, the first user may only be interested in having meetings with his top priority, whereas the second user may be open to meetings with anyone in the top ten, top twenty, etc. Perhaps each user will have a threshold rating, average rating, or weighted average rating, such as a 7 on a scale of 1 to 10, for example. The threshold that is set for the governing level of interest can be set by the system administrator, in some embodiments, by each of the users, or perhaps a combination of both the administrator and the users.

Consistent with the teachings provided herein, each user can choose for their ratings of others to remain private in some embodiments, or each user can choose for their ratings to be shared, so that the other user in a proposed meeting knows the relative level of interest that the user has in meeting them.

It should also be appreciated that any relative measure can be used, as the rating system does not have to be only numerical. FIG. 4D is a color scale that can be used for a visual indicator, or color rating, in some embodiments. Such rating system can be used just like numbers, meaning a single simple color can be assigned to the other user as a whole, or colors can be assigned to any of a variety of attributes that are selected to meet the purpose of the desired relationship. In FIG. 4D, white represents the lowest interest and black indicates the highest interest. Moreover, colors can also be weighted, so that the average color assigned reflects a weighting that may better reflect a user's needs from another user in the network. One method of weighting could be through the use of underlying numbers assigned to each color on the spectrum, using a weighting formula, perhaps like the formula provided above, to create a weighted color output.

Numbers and colors are not the only indicators of relative interest possible. Any units can be used to represent relative levels of interest. These levels of interest can be designed and selected by each user, perhaps as a personal coding system that is understood only by the user. In some embodiments, a disfavorable image can be used to reflect a low level of interest, where a favorable image can be used to reflect a high level of interest. In some embodiments, animals can be used, and the user can choose which animals reflect disfavorable and favorable images. In some embodiments, automobiles can be used. In some embodiments images of weather can be used. In some embodiments, emojis can be used. In some embodiments, avatars can be used.

Identifying Distributions of Users with a Distributions Module

It should be appreciated that each user of the system will have a different geographical location, and each geographical location can have users that are centralized, sparse, centralized in a variety of locations, and the like. One of skill in the art will appreciate having a distributions module on a non-transitory computer readable medium to provide a processor with instructions to help users locate nodes of users, the distribution module providing locations of nodes in some embodiments, and population densities in other embodiments. As in other embodiments taught herein, the distributions module can have a privacy feature that allows the user to turn the tracking on or off, depending on the user's privacy preference. Any location tracking system can be used, such as GPS tracking. One of skill will appreciate that the location tracking system can be refined to enhance the resolution of the system to locate one or more users within miles of each other, or within feet of each other, depending on the geographical location tracked, and the resolution needed.

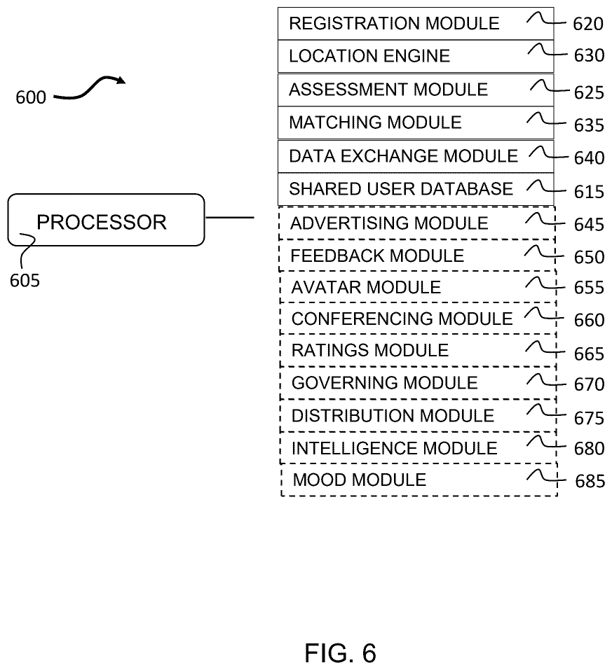

FIGS. 5A and 5B illustrate node distributions that are identified by geographical location, time of day, and population density, according to some embodiments. FIG. 5A represents a node of users of the network on Saturday, at 5p, and FIG. 5B shows the same geographical region on the same Saturday, at 9p. As shown in FIG. 5A, the largest node 505 having the highest population density is surrounded by two other nodes, a medium-sized node 525 having a medium-sized population density, and a smaller-sized node 515 having even smaller population densities. This helps the user identify where to go to meet other users that share in the network. For example, FIG. 5A may illustrate the distribution of users of the network that are attending a professional sporting event, wherein the highest population density 505 is at the sporting venue, the medium-sized population densities 525 being, perhaps in large sports bars near the venue, and the smaller-sized population densities 515 being perhaps at private homes or smaller bars or restaurants. As the time changed from 5p to 9p, the users of the system either logged-out or left the location. The distributions module allows users to locate population densities over time to identify where they can accomplish their goal of meeting other users for their intended purpose.

It should be appreciated that the size, distribution and location of the nodes will change, depending on the purpose of the meeting. This is also true of the geography. FIGS. 5A and 5B are more representative of a larger scale city location, whereas the distribution could also be a much smaller scale, such as within the sports venue itself in some embodiments, or even within the larger sports bar or the smaller sports bar or restaurant in some embodiments. The geography can also be a college campus, in some embodiments. A node distribution of users of the network that are interested in a romantic meeting will be different than a node distribution of users of the network that are interested in a platonic or business meeting, for example. It should also be appreciated that, in some embodiments, the distributions module can provide user identifier logistics within a node, such as sex, age, height, weight, athleticism, ethnicity, race, profession, political affiliation, IQ, ambitions, or any combination of any attributes offered by other users, to help the user identify where to go to meet other users.

The nodes can provide a direct link to driving directions, in some embodiments, where a user can select a node on a map and get directions to the location, operating hours of the business, the event that is taking place, contact information, and the like. In some embodiments, the nodes can also provide any other relevant information that may be applicable to the purpose of the meeting, such as ratio of men to women, ages, and other attributes that may be of interest to the user for the purpose of the meeting.

It should also be appreciated, however, that in some embodiments the systems may not track on geographical locations alone or at all but, rather, rely on a virtual presence, such that the meetings can include virtual meetings which are not geographically limited in the same manner as in-person meetings. In some embodiments, the geographical scope for use by the distributions module can be set by the user. For example, the user can choose a zip code(s), an area code(s), city name(s), or a distance from the user's location, such as a radius from the user in miles, kilometers, and the like. This allows the user to meet others virtually before meeting them in person at a physical location.

Identifying Targeted Populations of Users, or Particular Users, with an Intelligence Module

The systems can include an intelligence module to target populations of users, or particular types of users or individuals, with an intelligence module. The intelligence module is on a non-transitory computer readable medium and provides a processor with instructions to collect, assemble, provide user logistics that are apparently important to the user, without a need for the user to enter user preferences. The logistics may include, for example, sex, age, height, weight, athleticism, ethnicity, race, profession, political affiliation, IQ, ambitions, or any combination of any attributes offered by other users. The intelligence module will monitor user inputs, user views, and the activities of the user to help the user better identify candidates for meetings.

In some embodiments, the intelligence module will only monitor information within the confines of the systems taught herein. However, the intelligence module can be instructed to for example, monitor other activities, such as the content of YouTube views, Google searches, Instagram content, SnapChat content, Amazon searches, or the like.

The intelligence module can be used to help the user set-up in-person meetings and virtual meetings, in which the user has provided the system with a plethora of information that helps the system fit the user with better possible meetings with more success.

In some embodiments, a matching algorithm based on user profile inputs or/and data gathered based on user experience and their preferences for others of interest can automatically show where there are people who match your personal data patterns based on user inputs, and the personality and preference data patterns of other users.

For example, John goes to a conference and go for dinner after the day's session. He can pull up the app to show where there's a bar or restaurant with lots of people who fit his business interests. John locates where particular people who fit his business interest are hanging out and goes to that location.

This can be applied to people looking to meet new friends or just somebody to help with any needs, business or personal.

Identifying Users by their Present Mood Using a Mood Module

As any human will understand, the type of, and success of, human interactions that occur can depend in large part on the mood of the users that are interacting with each other. And, sometimes interactions can be initiated to address, or perhaps change, someone's mood. In some embodiments, the system can show the mood of one or more users of the system at a particular point in time using a mood module, the mood module is on a non-transitory computer readable medium and provides a processor with instructions to carry-out the function of at least displaying a user's mood on the system. The mood module can receive direct user input in some embodiments for display to other users of the system.

Each user can decide whether to post their mood for others to see. Perhaps, the mood can be shown only to a select subset of users, or perhaps just one user at a time. For example, a user may be looking for a romantic encounter and failing. The user may just be sad, or perhaps the user is contemplating self-harm. Another user of the system could reach out to the user, on the basis of mood alone, to help the user work through the problem.

Users may find that a display of their mood or emotions may be useful in any environment. In a job fair environment, a user may be elated and looking to celebrate a job offer, too frightened to speak with anyone and in need of a friend, or upset due to failures and in need of an intervention. In a university environment, a user may just feel alone and looking for a platonic friend; stressed and considering drugs or alcohol, looking for support; pressured by a peer group and looking for a fresh opinion; or, the like. As such, the systems taught herein can provide a social network that allows for select interactions that are influenced, or perhaps even initiated, as a result of the mood of one or more of the users of the system. Perhaps a user will choose to display mood to help initiate a match, whether in-person or virtual. For example, let's say John was sitting at a café and was depressed because his girlfriend just broke up with him. He indicates to the network that he is depressed, and another user that happens to be a psychologist was nearby and available to help.

### System Configurations

One of skill will appreciate that several embodiments are taught herein, including methods and systems that can be used to perform the methods. The methods taught herein require the configuration of systems having hardware and software that perform the operations taught. Generally speaking, the systems will include a processor that takes instructions from a memory on a non-transitory computer readable medium. The systems can include system inputs and system outputs, input devices, output devices, and the like.

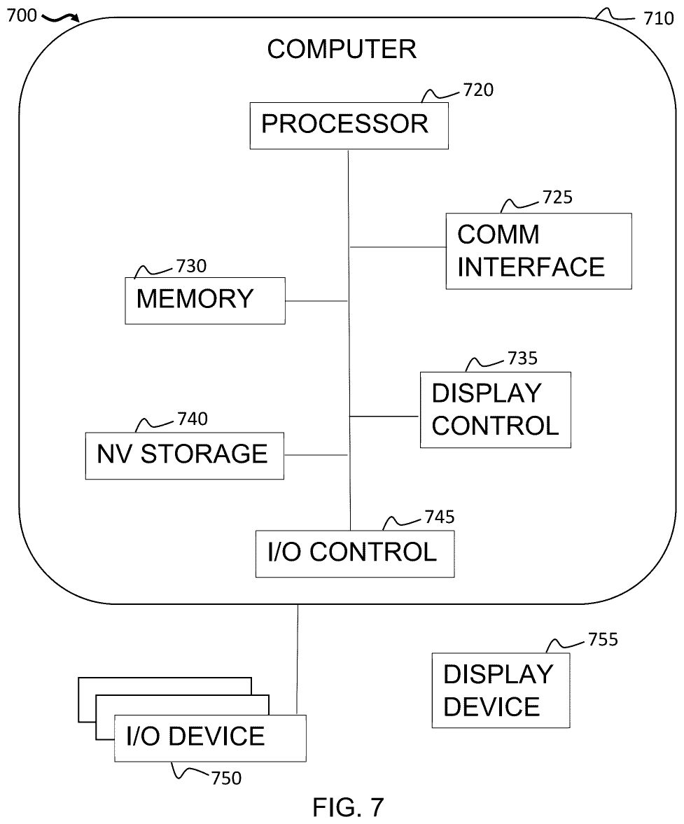

FIG. 6 illustrates processor-memory configurations for systems taught herein, the memory having an engine and modules that instruct the processor to perform tasks, according to some embodiments. The system 600 shown in FIG. 6 illustrates possible variations of how the modules and engine of the present teaching may be configured. In FIG. 6, for example, the solid lines indicate required components of the system illustrated, and the dashed lines indicate optional modules that can be used alone with the required components, or in any combination of optional modules with the required components.

The system 600 contains a processor 605 and a memory 610 (that can include non-volatile memory), wherein the memory 610 includes an shared user database 615, a registration module 620, an assessment module 625, a location engine 630, a matching module 635, a data exchange module 640 operable to exchange data with external computer readable media, an advertising module 645, and a feedback module 650. All engines and modules are on a non-transitory computer readable medium. The memory 610 is a non-transitory computer readable medium, for example.

The optional video display module (not shown) can also be a part of an output module (not shown). The system includes an input device (not shown) operable to receive audio data on a computer readable medium. Examples of input devices include a device in operable communication with the data exchange module operable 640 to interact with external data formats, voice-recognition software, and perhaps a hand-held device in communication with the system including, but not limited to, a microphone, and the like. A keyboard and a mouse are additional examples of input devices.

The shared user database 615 is operable to store user data for access on a computer readable medium. In some embodiments, the system can store information that is either secure or unsecured, and the user can tag or label any user data as secure or unsecured in some embodiments. Any data known to one of skill in the art can be stored as user information including, but not limited to sound files, text files, image files, and the like. In some embodiments, the system can access any of a variety of accessible data through the data exchange module 640, as discussed above.

The systems can include the use of text, audio, video, audiovisual, or any combination there. Where audio is used, any audio format known to one of skill in the art can be included in the systems taught herein. In some embodiments, the audio file comprises a format that supports one audio codec and, in some embodiments, the audio file comprises a format that supports multiple codecs. In some embodiments the audio file comprises an uncompressed audio format such as, for example, WAV, AIFF, and AU. In some embodiments, the audio file format comprises lossless compression such as, FLAC, Monkey's Audio having file extension APE, WavPack having file extension WV, Shorten, Tom's lossless Audio Kompressor (TAK), TTA, ATRAC Advanced Lossless, Apple Lossless, and lossless WINDOWS Media Audio (WMA). In some embodiments, the audio file format comprises lossy compression, such as MP3, Vorbis, Musepack, ATRAC, lossy WINDOWS Media Audio (WMA) and AAC.

In some embodiments, the audio format is an uncompressed PCM audio format, as a “.wav” for a WINDOWS computer readable media, or as a “.aiff” as a MAC OS computer readable media. In some embodiments a Broadcast Wave Format (BWF) can be used, allowing metadata to be stored in the file. In some embodiments, the audio format is a lossless audio format, such as FLAC, WavPack, Monkey's Audio, ALAC/Apple Lossless. In some embodiments, the lossless audio format provides a compression ratio of about 2:1. In some embodiments, the audio format is a free-and-open format, such as wav, ogg, mpc, flac, aiff, raw, au, or mid, for example. In some embodiments, the audio format is an open file format, such as gsm, dct, vox, aac, mp4/m4a, or mmf. In some embodiments the audio format is a proprietary format, such as mp3, wma, atrac, ra, ram, dss, msv, dvg, IVS, m4p, iklax, mxp4, and the like.

The registration module 620 embodied on a computer readable medium is operable to receive user information and preferences on how user information is used by the systems and methods taught herein. The registration module is used to obtain identification information about each user. In some embodiments, the identification information includes the name of the user. In some embodiments, the identification information includes the virtual address of the user and, in some embodiments, the identification information includes the physical address of the user. In some embodiments, the identification information includes physical attributes such as height weight, hair color, eye color, skin tone, tattoos, piercings, or any other physically apparent physical attributes that can be used to identify the user. In some embodiments, the identification information includes other characteristics such as the age, sex, race, ethnicity, political affiliation, choice of religion, and the like. The registration module 620 can also include other descriptions that can be used to identify or define the user, for example, the other descriptions may include user interests, opinions, hopes, dreams, possessions, photographs, and the like, such that the registration module 620 can be used as a portal for entry of user information into the system. And, as noted, the user information can be tagged or labeled as secure or unsecure, or perhaps is given a particular level of security that can be released at respective levels of relationships, the dissemination of each piece of information controlled by the user in some embodiments. In some embodiments, particular pieces of information may be considered mandatory for users to share. For example, a dating application may require verification of name, age, height, and weight, for example, for entry into the site to meet other users. In such embodiments, there may be other requirements, such as verification of a background check, crediting rating, or perhaps a clear blood screening or physical, to obtain entry into the system. Likewise, business applications of the system can include a requirement for the same or similar information. The system can also require that contracts be executed to assure that user information is safe, secure, and accurate, in some embodiments.

The assessment module 625 embodied on a computer readable medium is operable to record the user's assessment of other users. In some embodiments, the assessment module 625 can be secured or unsecured, and this can be a system configuration that can be selected and changed at any time by the user making the assessment. As such, in some embodiments, the user's assessment of another user can be a mere number rating, or some other measure that doesn't necessarily provide a detailed description but, rather, merely a relative rating of one or more characteristics of another user. In some embodiments, the assessment of the other user can be in text and, in some embodiments, the assessment of the user can be in text and descriptive in detail. In some embodiments, the assessment of the user can be an audio or audiovisual recording. And, in some embodiments, the assessment of the user can be provided in real-time, whether by text, audio, or audiovisual. For example, a first user can contact a second user about a third user of the system, and the second user can assess the third user in real-time to the first user by text chat, by audio, or by audiovisual communication in such embodiments.

The location engine 630 embodied on a computer readable medium is operable for identifying the location of a user in the shared user environment. In some embodiments, a first user can identify the location of a second user. In some embodiments, a first user can identify the location of several other users. In some embodiments, a first user can identify the location of all other users. In some embodiments, a user in the shared user environment can choose to keep their location secure and protected from disclosure to other users. In some embodiments, a user in the shared user environment can choose to disclose their location to only users in a select geographical area. In some embodiments, a user in the shared user environment can choose to disclose their location to only select users in a select geographical area. In some embodiments, a user in the shared user environment can choose to disclose their location to only select users anywhere in the shared user environment. In some embodiments, a user in the shared user environment can choose to prevent disclosure of their location to one or more users in the network. In some embodiments, a user can operate under an identifier, any identifier perhaps an alphanumeric identifier, which can be used to disclose location without disclosing the actual identity of the user. In such embodiments, the location of a user can be disclosed without sacrificing the privacy of the actual user of the system. These embodiments allow the system to at least keep track of, and display, a user density at a particular geographical, or virtual, location. For example, a first user with a first anonymous identifier can allow the system to disclose his actual information, whereas a second user with a second anonymous identifier may choose to stay anonymous, allowing the location engine to establish a second location of the second anonymous identifier in the shared user environment. The location engine can be configured to provide, or assist in providing, any location-relevant feature of the system taught herein, meaning a feature that utilizes an actual physical or virtual location to provide a function.

The matching module 635 embodied on a computer readable medium is operable to the matching module operable for the first user to identify a match with the second user and the second user to identify the match with the first user, the matching module notifying the first user and the second user of the match; a data exchange module on a non-transitory computer readable medium, the data exchange module operable for the first user to communicate with the second user upon the identification of the match, and the second user to communicate with the first user upon the identification of the match; and, a shared user database on a non-transitory computer readable medium, the shared user database operable for storing personal information, location information, and the anonymous identifiers of n users, in which n is a number of users ranging from 2 users to any number of users, of which at least the first user and the second user are in the shared user environment. In such embodiments, each of the first user and the second user are notified of the match by the matching module and have the option to communicate with the other user through the data exchange module. In some embodiments, the matching module matches selections of the users to help users identify a mutual interest. In some embodiments, the matching module matches selections of the users by relative user rankings to help users identify a mutual interest. In some embodiments, the matching module matches selections of the users by relative user rankings in select categories to help users identify a mutual interest. In some embodiments, the matching module matches selections of the users by relative user rankings in weighted, select categories to help users identify a mutual interest.

The matching module 635 can include a matching algorithm and, in some embodiments, the matching algorithm can be based on user profile inputs or/and data gathered based on user experience and their preferences for others of interest can automatically show where there are people who match your personal data patterns based on user inputs, and the personality and preference data patterns of other users. In some embodiments, for example, the matching algorithm can include a personal interest ranking system, for example EDGERANK, to include what each user shows an interest in with regard to news feeds. In some embodiments, for example, the matching algorithm can include a personal interest ranking system, for example PAGERANK, to include what each user shows an interest in with regard to search engine searches, results, selections, and links. Any such matching algorithm known in the art that can be used to identify relative user interests can be used, and the algorithm contains additional terms that are used to match one user to another user. In some embodiments, the user-to-user match is qualified or quantified by a numerical measure to assess the quality or nature of the match to the users. In some embodiments, the user-to-user match is qualified or quantified by a numerical measure to assess the quality or nature of the match to the users, including the presence of various places for agreement and/or conflict expected between the users by topic.

The advertising module 645 embodied on a non-transitory computer readable medium instructs the processor to identify particular user location data and activity tracking data, and to target advertising to those particular users. In some embodiments, the user can use the advertising module to opt-in to, or opt-out of, such advertising. The user may want to opt-in to use of the advertising module, as opting-in can reduce or eliminate the user's costs of participating in the system, in some embodiments.

The feedback module 650 embodied on a non-transitory computer readable medium instructs the processor to receive and record feedback by one or more users of the system, the user on other uses, and on the user by other users, as the users interact through the system. In some embodiments, it is optional to give and/or receive or view feedback. In some embodiments, the system can flag the feedback as positive or negative, and the flagging can be used by the user to label and choose the type of feedback they prefer to see. In some embodiments, the feedback can be anonymous. In some embodiments, the feedback can be selectively public, chosen by the recipient of the feedback for display to the network. In some embodiments, the feedback can be deleted by the provider, the recipient, or both.

The avatar module 655 embodied on a non-transitory computer readable medium instructs the processor to create avatars designed or selected by users of the system. In some embodiments, the avatars are pre-designed and available through the system. In some embodiments, the avatars can be designed by the user with the avatar module to simulate their actual size, shape, weight, age, skin color, hair color, hair style, or any combination thereof; or, the user can design any fictional avatar that they wish to use. The fictional avatar can be any character . . . an animal in some embodiments, a vehicle in some embodiments, an arbitrary or abstract item, and the like. In some embodiments, users can design and use avatars of themselves which, for example, can be constructed from photographs. In some embodiments, a 3D representation can be sourced from 3D scanner or construction from taking pictures of the subject at different angles. In some embodiments, the system can build a 3D avatar from multi-angle pictures of the subject.

The conferencing module 660 on a non-transitory computer readable medium instructs the processor to hold conferences between users of the system. In some embodiments, the conference is a teleconference. In some embodiments, the conference is a video conference. In some embodiments, each user in the conference is at a remote location. In some embodiments, the users may form groups of people, each group forming a “side” of a conferencing interaction. For example, a shared user environment may include, perhaps, 5 conference participants on each side of the conference. The participants on one side are represented by A, B, C, D, E nodes while those on the other side are F, G, H, I and J nodes. In some embodiments, the identities of all participants are protected, and only the appearance and behaviors of each participant are seen by all. Any subject can be chosen for discussion, for example, depending on the purpose of the conference, the subject being a main feature that defines the shared user environment. For example, there can be a meetup for wine enthusiasts and all can call in to talk about wine. Any group having any particular interest can form and meet to identify users having a shared interest that might also develop a mutual interest in each other. Since identities are kept confidential, anonymous connections can be made as described above. User A might have an interest in both user G and user J on the call, and user J might have an interest in user A and user C on the call. The matching module would alert user A and user J that they have a match and the data exchange module can give them options to communicate including, as in the other embodiments taught herein, an offer to meet in another shared-and-secure user environment to talk more in a group, simply chat with each other alone, or perhaps even reveal themselves to each other for a real-time, in-person meeting.

The ratings module 665 embodied in a computer readable medium instructs the processor to measure and assess relative levels of interest in other users. In some embodiments, the ratings module allows users to look at ratings about themselves from other users. Ratings can be simple, as a single measure, or complex with any number of measures, and the measures can be weighted in some embodiments. Likewise, ratings can be editable, or they can be locked, and ratings can be accumulated over time to measure change in ratings over time. See Example 1 for descriptions of using the ratings module 665.

The governing module 670 embodied in a computer readable medium instructs the processor to set a governing level of interest in a user's database before the system recognizes a mutual interest in a meeting. See Example 1 for descriptions of using the governing module 670.

The distribution module 675 embodied in a computer readable medium instructs the processor to help users locate nodes of users of the system, the distribution module providing locations of nodes in some embodiments, and population densities in other embodiments. See Example 2 for descriptions of using the distributions module 675.

The intelligence module 680 embodied on a computer readable medium instructs the processor to target and compile the select logistics of users of the system, populations of users, or particular types of users or individuals, within the system, whether as a whole, within a select geographic location, within a select group of users, and the like. The intelligence module instructs the processor to collect, assemble, provide user logistics that are apparently important to the user, without a need for the user to enter user preferences. The intelligence module 680 is self-learning software that uses prediction models to help the user identify better candidates for meetings. The logistics may include, for example, sex, age, height, weight, athleticism, ethnicity, race, profession, political affiliation, IQ, ambitions, or any combination of any attributes offered by other users. The intelligence module will monitor user inputs, user views, and the activities of the users of the system. See Example 3 for descriptions of using the intelligence module 680.

The mood module 685 embodied on a computer readable medium instructs the processor to show the mood of one or more users of the system. In some embodiments, the system can show the mood of one or more users of the system at a particular point in time using the mood module. The mood module can receive direct user input in some embodiments for display to other users of the system and, in some embodiments, the user can keep their mood secure from display, unsecured for open display to all, or unsecured for select persons of interest. See as taught herein for descriptions of using the mood module 685.

The system can include an output module (not shown) embodied in a computer readable medium, wherein the output module is operable to transmit data to an output device. The output device can be, which can be a graphical user interface, or video display, which can optionally be supported by a separate video display module (not shown), or the display can be supported with one or more other output devices by the output module (not shown). The output device can be operable to provide data to the user, wherein the data assists the user in operating the systems and methods taught herein. In some embodiments, the input device comprises a microphone and, in some embodiments, the output module transmits music transcription and tablature data to a graphical user interface. In some embodiments, the output device comprises a speaker, a graphical user interface, or both a speaker and a graphical user interface, for example.

The CPU on a handheld computer system can have difficulties concurrently processing the data files described herein. In some embodiments, a handheld computing system may have latency difficulties when concurrently processing more than 2 audio data files, for example. As such, data files may require compression. In some embodiments, the data files can be compressed using a compression technique, for example, such as QUICKTIME by Apple. Other file compression techniques can be used. IMA4 can also be used to compress the files in some embodiments. In some embodiments, compressed audio data files may be needed for use of some embodiments of the system on portable devices. The IMA4 compression method, for example, compresses the audio data file to about 25% of file size.

In some embodiments, it should be appreciated, however, that the system can use pure, uncompressed wave files. Most home PCs, however, will not need compressed files due to the more powerful processors currently available for home PCs. The bandwidth of the computer system, i.e. the size of the CPU and memory will dictate whether compression is necessary. One of skill in the art will appreciate that certain compression technologies may be needed in some systems for optimum performance and that these technologies are readily identifiable and accessible.

As described above, the system can include a data exchange module 640 embodied on a computer readable medium, wherein the data exchange module is operable to exchange data with external computer readable media. The data exchange module 640 can, for example, serve as a messaging module operable to allow users to communicate with other users having like subject-profiles, or others users in a profile independent manner, merely upon election of the user. The users can email one another, post blogs, or have instant messaging capability for real-time communications. In some embodiments, the users have video and audio capability in the communications, wherein the system implements data streaming methods known to those of skill in the art. In some embodiments, the system is contained in a hand-held device; operable to function as a particular machine or apparatus having the additional function of telecommunications, word processing, or gaming; or operable to function as a particular machine or apparatus not having other substantial functions.

The systems taught herein can be practiced with a variety of system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network. As such, in some embodiments, the system further comprises an external computer connection through the data exchange module 245 and a browser program module (not shown). The browser program module (not shown) can be operable to access external data as a part of the data exchange module 640.

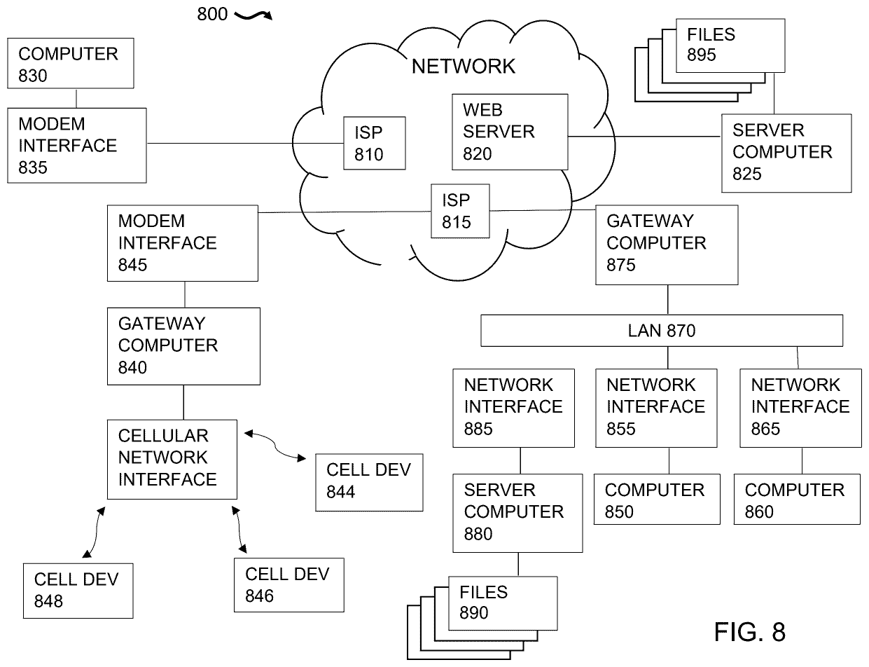

FIG. 7 illustrates how the processor and memory can fit within a computer system having system inputs and system outputs, input devices, output devices, according to some embodiments. The computer system 700 may be a conventional computer system and includes a computer 705, I/O devices 750, and a display device 755. The computer 705 can include a processor 720, a communications interface 725, memory 730, display controller 735, non-volatile storage 740, and I/O controller 745. The computer system 700 may be coupled to or include the I/O devices 750 and display device 755.

The computer 705 interfaces to external systems through the communications interface 725, which may include a modem or network interface. It will be appreciated that the communications interface 725 can be considered to be part of the computer system 700 or a part of the computer 705. The communications interface 725 can be an analog modem, isdn modem, cable modem, token ring interface, satellite transmission interface (e.g. “direct PC”), or other interfaces for coupling the computer system 700 to other computer systems. In a cellular telephone, this interface is typically a radio interface for communication with a cellular network and may also include some form of cabled interface for use with an immediately available personal computer. In a two-way pager, the communications interface 725 is typically a radio interface for communication with a data transmission network but may similarly include a cabled or cradled interface as well. In a personal digital assistant, the communications interface 725 typically includes a cradled or cabled interface and may also include some form of radio interface, such as a BLUETOOTH or 802.11 interface, or a cellular radio interface, for example.

The processor 720 may be, for example, a conventional microprocessor such as an Intel Pentium microprocessor or Motorola power PC microprocessor, a Texas Instruments digital signal processor, or a combination of such components. The memory 730 is coupled to the processor 720 by a bus. The memory 730 can be dynamic random access memory (DRAM) and can also include static ram (SRAM). The bus couples the processor 720 to the memory 730, also to the non-volatile storage 740, to the display controller 735, and to the 1/O controller 745.

The I/O devices 750 can include a keyboard, disk drives, printers, a scanner, and other input and output devices, including a mouse or other pointing device. The display controller 735 may control in the conventional manner a display on the display device 755, which can be, for example, a cathode ray tube (CRT) or liquid crystal display (LCD). The display controller 735 and the 1/O controller 745 can be implemented with conventional well known technology, meaning that they may be integrated together, for example.

The non-volatile storage 740 is often a FLASH memory or read-only memory, or some combination of the two. A magnetic hard disk, an optical disk, or another form of storage for large amounts of data may also be used in some embodiments, although the form factors for such devices typically preclude installation as a permanent component in some devices. Rather, a mass storage device on another computer is typically used in conjunction with the more limited storage of some devices. Some of this data is often written, by a direct memory access process, into memory 730 during execution of software in the computer 705. One of skill in the art will immediately recognize that the terms “machine-readable medium” or “computer-readable medium” includes any type of storage device that is accessible by the processor 720 and also encompasses a carrier wave that encodes a data signal. Objects, methods, inline caches, cache states and other object-oriented components may be stored in the non-volatile storage 740, or written into memory 730 during execution of, for example, an object-oriented software program.

The computer system 700 is one example of many possible different architectures. For example, personal computers based on an Intel microprocessor often have multiple buses, one of which can be an I/O bus for the peripherals and one that directly connects the processor 720 and the memory 730 (often referred to as a memory bus). The buses are connected together through bridge components that perform any necessary translation due to differing bus protocols.

In addition, the computer system 700 can be controlled by operating system software which includes a file management system, such as a disk operating system, which is part of the operating system software. One example of an operating system software with its associated file management system software is the family of operating systems known as Windows®, Windows CE®, and Windows NT® and from Microsoft Corporation of Redmond, Washington, and their associated file management systems. Another example of operating system software with its associated file management system software is the LINUX operating system and its associated file management system. Another example of an operating system software is the Android® system, known as a mobile operating system based on a modified version of the LINUX kernel and other open source software, mainly for touchscreen mobile devices, such as smartphones and tablets. The file management system is typically stored in the non-volatile storage 740 and causes the processor 720 to execute the various acts required by the operating system to input and output data and to store data in memory, including storing files on the non-volatile storage 740. Other operating systems may be provided by makers of devices, and those operating systems typically will have device-specific features which are not part of similar operating systems on similar devices. The most common operating systems are Windows®, MacOS®, Linux®, Unix®, and for mobile, iOS®, Android® OS, Windows® OS, Blackberry® OS, Symbian®, and Bada®.

The computer system 700 may be integrated onto a single chip or set of chips in some embodiments, and can be fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

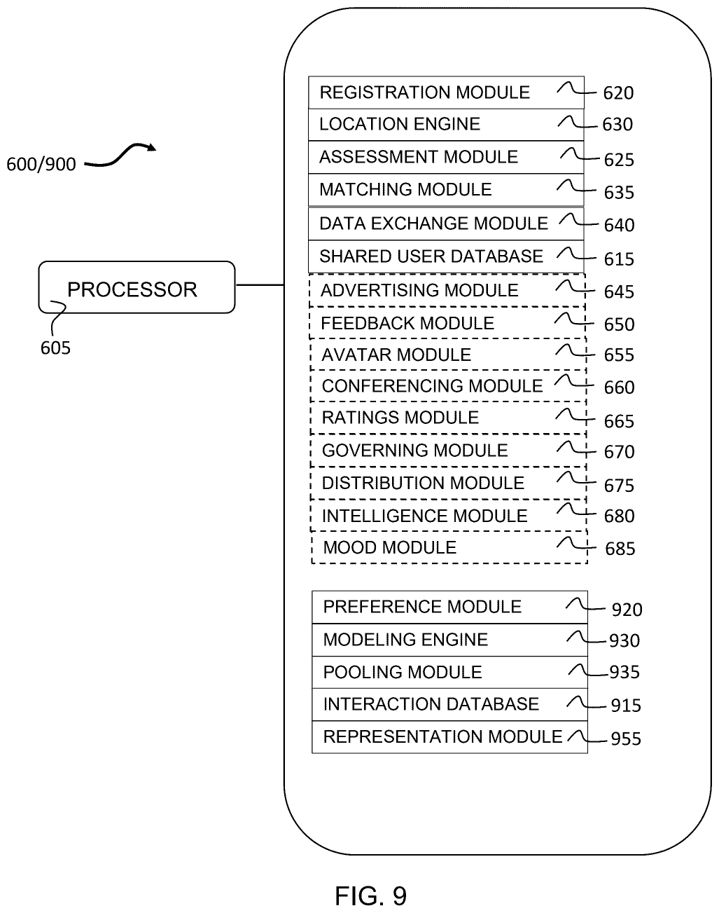

FIG. 8 illustrates how a network can be used for the methods and systems taught herein, according to some embodiments. FIG. 8 shows several computer systems coupled together through a network 805, such as the internet, along with a cellular network and related cellular devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 805 is typically provided by internet service providers (ISP), such as the ISPs 810 and 815. Users on client systems, such as client computer systems 830, 850, and 860 obtain access to the internet through the internet service providers, such as ISPs 810 and 815. Access to the internet allows users of the client computer systems to exchange information, receive and send e-mails, and view documents, such as documents which have been prepared in the HTML format. These documents are often provided by web servers, such as web server 820 which is considered to be “on” the internet. Often these web servers are provided by the ISPs, such as ISP 810, although a computer system can be set up and connected to the internet without that system also being an ISP.

The web server 820 is typically at least one computer system which operates as a server computer system and is configured to operate with the protocols of the worldwide web and is coupled to the internet. Optionally, the web server 820 can be part of an ISP which provides access to the internet for client systems. The web server 820 is shown coupled to the server computer system 825 which itself is coupled to web content 895, which can be considered a form of a media database. While two computer systems 820 and 825 are shown in FIG. 8, the web server system 820 and the server computer system 825 can be one computer system having different software components providing the web server functionality and the server functionality provided by the server computer system 825 which will be described further below.

Cellular network interface 843 provides an interface between a cellular network and corresponding cellular devices 844, 846 and 848 on one side, and network 805 on the other side. Thus cellular devices 844, 846 and 848, which may be personal devices including, for example, cellular telephones, two-way pagers, personal digital assistants or other similar devices, may connect with network 805 and exchange information such as email, content, or HTTP-formatted data, for example. Cellular network interface 843 is coupled to computer 840, which communicates with network 805 through modem interface 845. Computer 840 may be a personal computer, server computer or the like, and serves as a gateway. Thus, computer 840 may be similar to client computers 850 and 860 or to gateway computer 875, for example. Software or content may then be uploaded or downloaded through the connection provided by interface 843, computer 840 and modem 845.

Client computer systems 830, 850, and 860 can each, with the appropriate web browsing software, view HTML pages provided by the web server 820. The ISP 810 provides internet connectivity to the client computer system 830 through the modem interface 835 which can be considered part of the client computer system 830. The client computer system can be a personal computer system, a network computer, a web TV system, or other such computer system.

Similarly, the ISP 815 provides internet connectivity for client systems 850 and 860, although as shown in FIG. 8, the connections are not the same as for more directly connected computer systems. Client computer systems 850 and 860 are part of a LAN coupled through a gateway computer 875. While FIG. 8 shows the interfaces 835 and 845 as generically as a “modem,” each of these interfaces can be an analog modem, isdn modem, cable modem, satellite transmission interface (e.g. “direct PC”), or other interfaces for coupling a computer system to other computer systems.

Client computer systems 850 and 860 are coupled to a LAN 870 through network interfaces 855 and 865, which can be ethernet network or other network interfaces. The LAN 870 is also coupled to a gateway computer system 875 which can provide firewall and other internet related services for the local area network. This gateway computer system 875 is coupled to the ISP 815 to provide internet connectivity to the client computer systems 850 and 860. The gateway computer system 875 can be a conventional server computer system. Also, the web server system 820 can be a conventional server computer system.

Alternatively, a server computer system 1980 can be directly coupled to the LAN 870 through a network interface 1985 to provide files 1990 and other services to the clients 850, 860, without the need to connect to the internet through the gateway system 875.

Through the use of such a network, for example, the system can also provide an element of social networking, whereby users can contact other users having similar subject-profiles. In some embodiments, the system can include a messaging module operable to deliver notifications via email, SMS, and other mediums. In some embodiments, the system is accessible through a portable, single unit device and, in some embodiments, the input device, the graphical user interface, or both, is provided through a portable, single unit device. In some embodiments, the portable, single unit device is a hand-held device.

### Using Machine Learning to Model User Preferences Using Actual Interaction Data Iteratively for an Improved Candidate Pool.

Machine learning is form of artificial intelligence or A.I. that can use pattern and trend detection for making improved decisions, or deriving non-obvious solutions, by training the machine to learn and model to make better decisions in subsequent (though not identical) situations. There are many different types of machine learning algorithms, with hundreds published each day, and they're typically grouped by either learning style (i.e., supervised learning, unsupervised learning, semi-supervised learning) or by similarity in form or function (i.e., classification, regression, decision tree, clustering, deep learning, etc.). Regardless of learning style or function, all combinations of machine learning algorithms consist of the following:
Representation (a set of classifiers or the language that a computer understands)
Evaluation (aka objective/scoring function)
Optimization (search method; often the highest-scoring classifier, for example; there are both off-the-shelf and custom optimization methods used)

Supervised Machine Learning applies what has been learned in the past to new data using labeled examples to predict future events. Starting from analyzing a known training dataset, the learning algorithm produces an inferred function to predict the output values. The system is able to provide targets for any new input after sufficient training. The learning algorithm can also compare its output with the correct, intended output and find errors in order to modify the model accordingly. Supervised learning matches inputs to outputs in training.

Unsupervised machine learning is used when the information used to train is neither classified nor labeled. Unsupervised learning studies how systems can infer a function to describe a hidden structure from unlabeled data. The system doesn't figure out the right output, but it explores the data and can draw inferences from datasets to describe hidden structures from unlabeled data. Unsupervised machine learning trains using only inputs, without labeled training data however, looking for commonalities in data in the input rather looking at outcomes in the output. Cluster analysis can be used in unsupervised machine learning, where data is placed in “clusters”, which as subsets that group the data for modeling.

Semi-supervised machine learning uses some labeled training data, usually a small amount, and so it falls between supervised and unsupervised learning since they use both labeled and unlabeled data for training—typically a small amount of labeled data and a large amount of unlabeled data. The systems that use this method are able to improve learning accuracy considerably. Usually, semi-supervised learning is chosen when the acquired labeled data requires skilled and relevant resources in order to train it and learn from it.

Reinforcement machine learning interacts with its environment by producing actions and discovering errors or rewards. Trial and error search and delayed reward are the most relevant characteristics of reinforcement learning. This method allows machines and software agents to automatically determine the ideal behavior within a specific context in order to maximize its performance. Simple reward feedback is required for the agent to learn which action is best; this is known as the reinforcement signal.

Decision tree learning uses a decision tree as a predictive model to go from observations about an item (represented in the branches) to conclusions about the item's target value (represented in the leaves). It is one of the predictive modeling approaches used in machine learning. Tree models where the target variable can take a discrete set of values are called classification trees; in these tree structures, leaves represent class labels, and branches represent conjunctions of features that lead to those class labels.

In some embodiments, the systems and methods use a supervised learning model. In some embodiments, the systems and methods use an unsupervised learning model. In some embodiments, the systems and methods use a semi-supervised learning model. In some embodiments, the systems and methods use a reinforcement machine learning model. In some embodiments, the systems and methods use a decision tree learning. In some embodiments, the machine learning is a recommender system, for example, such as the recommender system used by Amazon, YouTube, or Netflix. In some embodiments, the systems and methods use an artificial neural network having an input layer, an output layer and a plurality of hidden layers that act as both input and output layers to help understand the more complex relationships between user interactions and the modeled preferences developed, or derivatized, from the user's initial set of preconceived preferences.

In some embodiments, the systems and methods taught herein are based on use of “limited memory” A.I. systems which reference the past, and information is added over a period of time, although the referenced information is short-lived. And, in some embodiments, the systems and methods taught herein are based on “theory of mind”, which are able to understand human emotions and how they affect decision making; and, they are trained to adjust their behavior accordingly. In some embodiments, the systems and methods herein can evolve into “deep learning” systems when, and if, enough structured data can become available in the network for use of such a neural network system. An example of such a system and method is a recurrent neural network that uses sequential information to build a model which may add computational power by memorizing past data for improving it's power. And, in some embodiments, the systems and methods taught herein can often include “similarity learning” to measure ranking between candidates, similarities/differences in behavior between and among candidates, face recognition, and voice recognition.

A machine learning method of modeling preference data to optimize candidate partners of interest for a user interaction is provided in some embodiments. Any of the system configurations taught herein can be used or combined to provide any of the methods and systems taught herein. FIGS. 6-9, for example, teach system configurations, each of which can be used for embodiments taught herein.

A machine learning method provided herein can include gathering initial preference data from a user of a networking community. The “networking community” can be defined as any matching community in which the systems and methods taught herein may be implemented. For example, the networking community may be a closed community that is bounded by only the members of a particular matching community. The networking community may also be an open community that may have a networking subpopulation but also has a larger more expansive population that may have some data accessible to non-members.

It should be appreciated that the “preference data” can include any data that establishes a criteria, is a criteria, or is part of a criteria, for the candidate partner to meet in order to fall within a user preference. For example, “preference data”, in some embodiments, can include any trait that the user may want to find in a candidate partner, for example, sexual preference, political preference, religious preference, social tolerances, appearance, age, health, temperament, income, profession, intelligence, humor, parenting practices, hobbies, activity level, personal goals, expectations of a partner, and the like.

The methods provided herein can include assembling a pool of candidate partners for the user from within the matching network based on the initial preference data from the user, each candidate in the pool meeting the set of criteria within an acceptable deviation threshold used by the method to select each candidate in the pool.

The methods taught herein model preference data from actual interaction data, so the method can include obtaining a plurality of sets of interaction data from the user, each set in the plurality of sets representing the user's assessment of an actual interaction with a respective candidate in the initial pool. In order to generate a useful model, the method can include developing a machine learning model with the plurality of sets of interaction data, the machine learning model suitable for accepting the plurality of sets of interaction data from the user as an input and functioning to produce a modeled preference data for the user as an output, the developing including
selecting the machine learning model;
preparing the plurality of sets of interaction data for use in training and testing the model, the preparing including splitting the data into training data for training the model, and testing data for testing the model;
training the model with the training data, the training including selecting training variables;
testing the model with the testing data to evaluate the utility of the output;
improving the performance of the machine learning model, the improving including adjusting the variables in the training to improve the output of the model.

By improving the user's preferences through modeling, the ability to improve upon a user's preconceived, or initial, set of preferences in a way that may not have been contemplated by the user. This will allow for a method that includes creating a modified pool of candidate partners using the output of the model from the input of the plurality of sets of interaction data. The model can be just a one step improvement, and it may be discovered that the one step didn't improve the user's preferences at all. In some embodiments, the model can include an iterative approach, for example, modeling preference data for the user using an iterative application of the model that includes repeating the assembling, the providing, the obtaining, the developing, and the creating to optimize the candidate partners for a user interaction. The iterative approach can be done over a shorter term of days, weeks, or months in some embodiments, or perhaps done over a longer term, such as months or years in other embodiments.

The number of candidates in a pool can vary, and it may be helpful to the user to rank the candidates to help in selecting interactions. In some embodiments, the method can include providing initial match scores to the user for selecting interactions to pursue, the initial match scores including a numerical assessment that provides a measure-of-fit of each candidate to the set of criteria. The measure-of-fit can be calculated using any known mathematical method. And, the measure-of-fit can be an average of measure of fit to the criteria as a whole, where the criteria is the complete set of preferences. In some embodiments, the preferences can be presented as weighted criteria. And, in some embodiments, the measure-of-fit can be a fit to particular preferences representing criteria that the user may want to compare individually. In some embodiments, the providing of the initial match scores is limited to candidates that meet an acceptable deviation selected by the user.

Since there are at least two parties to an interaction, and both parties should be satisfied in the match. As such, it would be valuable to have a machine learning method of modeling preference data to optimize candidate partners of interest for both users in an interaction to help ensure a mutual interest, or mutual qualification, between users. It should be appreciated that a “mutual interest” can be an express emotional mutual interest direct from the user; or, a mutual interest can be determined by a machine learning model, as set forth herein.

In these embodiments, the methods can include gathering initial preference data from a first user of a networking community, and gathering initial preference data from a second user of the networking community. Since there are two sets of preference data, the method also functions for assembling a first pool of candidate partners for the first user from within the matching network based on the initial preference data from the first user, each candidate in the first pool meeting the set of criteria within an acceptable deviation threshold used by the method to select each candidate in the first pool; and, assembling a second pool of candidate partners for the second user from within the matching network based on the initial preference data from the second user, each candidate in the second pool meeting the set of criteria within an acceptable deviation threshold used by the method to select each candidate in the second pool.

In order to model inputs that represent each user, at least from the perspective of the user, the method can include obtaining a plurality of sets of interaction data from the first user, each set in the plurality of sets representing the first user's assessment of an actual interaction with a respective candidate in the initial pool; and, obtaining a plurality of sets of interaction data from the second user, each set in the plurality of sets representing the second user's assessment of an actual interaction with a respective candidate in the initial pool. The data allows for development of a machine learning model. As such, the method can include developing a machine learning model with the plurality of sets of interaction data from the first user as a first input, and the plurality of sets of interaction data from the second user as a second input, the machine learning model suitable for accepting the first input and the second input, and functioning to produce a first modeled preference data for the first user in a first output and a second modeled preference data for the second user in a second output, the developing including
selecting the machine learning model;
preparing the first input and the second input for use in training and testing the model, the preparing including splitting (i) the first input into a first training data and a first testing data; and, (ii) the second input into a second training data and a second testing data;
training the model with the first training data, the training including selecting training variables;
testing the model with the first testing data to evaluate the utility of the output; training the model with the second training data, the training including selecting training variables;
testing the model with the second testing data to evaluate the utility of the output;
improving the performance of the machine learning model, the improving including adjusting the variables in the training to improve the output of the model;

The modeled preferences allow for a method that includes creating a modified pool of candidate partners for the first user using the output of the model from the plurality of sets of interaction data from the first user; and, creating a modified pool of candidate partners for the second user using the output of the model from the plurality of sets of interaction data from the second user. In fact, the model can include an iterative approach, for example, modeling preference data for the first user using an iterative application of the model that includes repeating the assembling, the providing, the obtaining, the developing, and the creating to optimize the candidate partners for a user interaction for the first user; and, modeling preference data for the second user using an iterative application of the model that includes repeating the assembling, the providing, the obtaining, the developing, and the creating to optimize the candidate partners for a user interaction for the second user; wherein, the candidate partners for the interaction for the first user are modified to exclude the second user when the candidate partners for the second user do not include the first user; and, the candidate partners for the interaction for the second user are modified to exclude the first user when the candidate partners for the first user do not include the second user.

As in the case of the modeling for the one user, the method can be configured for providing initial match scores to the first user and the second user for selecting interactions to pursue, the initial match scores including a numerical assessment that provides a measure-of-fit of each candidate to the set of criteria. In some embodiments, the providing of the initial match scores is limited to candidates that meet an acceptable deviation selected by the user.

It can be valuable to visualize the improvements that the machine learning model is making to user preferences. This can be done using numerical data, text information, or graphical images, or any combination thereof. As such, in some embodiments, a machine-learning method of optimizing a match for a user of a matching network is provided by comparing a modeled virtual, ideal partner to a candidate partner. The method can include creating an initial virtual, ideal partner, Pvi, for the user of the network based on initial preference data as input obtained from the user. In these embodiments, the creating can include gathering initial preference data from the user of the network, the initial preference data including a set of criteria selected by the user; and, forming a representation of the Pvi for the user of the network based on the initial preference data from the user. It should be appreciated that the virtual image can be output based on any number of factors such as, for example, appearance, age, health, activity level, and the like.

As in other embodiments, the method can include assembling an initial pool of candidate partners for the use from within the matching network based on the initial preference data from the user, each candidate in the initial pool meeting the set of criteria within an acceptable deviation threshold used by the method to select each candidate in the initial pool.

These embodiments can also include providing initial match scores to the user for selecting interactions to pursue, the initial match scores including a numerical assessment that measures the fit of each candidate to the set of criteria. In some embodiments, the providing of the initial match scores is limited to candidates that meet an acceptable deviation selected by the user.

In order to train and test the machine learning model, the method can include obtaining a plurality of sets of interaction data from the user, each set in the plurality of sets representing the user's assessment of an actual interaction with a respective candidate in the initial pool. As such, the method can include developing a machine learning model with the plurality of sets of interaction data, the machine learning model suitable for accepting the plurality of sets of interaction data from the user as an input and functioning to produce a modeled preference data for the user as an output, the developing including
selecting the machine learning model;
preparing the plurality of sets of interaction data for use in training the model, the preparing including splitting the data into training data for training the model, and testing data for testing the model;
training the model with the training data, the developing including selecting training variables;
testing the model with the testing data to evaluate the utility of the output; and,
improving the performance of the machine learning model, the improving including adjusting the variables in the training process to improve the output of the model.

In order to use the model to general modeled preferences that improve the candidate pool, the method can include iterating the model stepwise from Pvi to a modeled, virtual ideal partner, Pvmn, where n ranges from 1 to T, and T is the total number of iterations of the model, the modifying including creating each Pvmn from modeled preference data output by the model at each iteration.

Once the modeled preference data is generated at each iteration, the method can include modifying the pool of candidate partners at each iteration using the modeled preference data for each Pvmn.

After the user is satisfied with the candidate pool, or the system has reached a convergence that results no further improvements, or no statistically significant improvements likely using standard statistical measures, the method can include forming a representation of PvmT for the user of the network based on the modeled preference data from the user. As noted, T can be decided by the user, by the system settings, or a combination of both.

In some embodiments, the representation of Pvi is a data representation. In some embodiments, the representation of Pvi is a graphical representation that includes an image of Pvi. In some embodiments, the representation of PvmT is a data representation. In some embodiments, the representation of PvmT is a graphical representation that includes an image of PvmT. In some embodiments, the method includes forming a representation of each Pvmn for the user of the network at each iteration, the representation including an image of each Pvmn.

A machine learning system is also provided for modeling preference data to optimize candidate partners of interest for a user interaction. These systems comprise a processor and a memory.

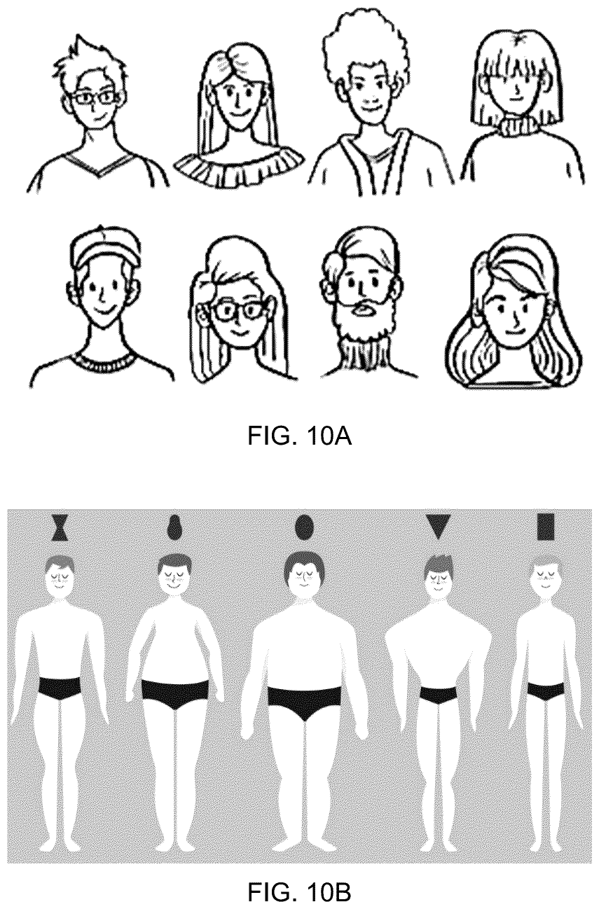

FIG. 9 illustrates a machine learning system, according to some embodiments. The system 600/900 can include a combination of modules and engines. In addition to the processor 605, and the other components that may be present as taught in the system 600, the memory can also include a preference module 920 on a non-transitory computer readable medium operable for receiving and storing initial preference data from a user of a networking community; a pooling module 935 on a non-transitory computer readable medium operable for assembling a pool of candidate partners for the user from within the matching network based on the initial preference data from the user, each candidate in the pool meeting the set of criteria within an acceptable deviation threshold used by the method to select each candidate in the pool; an interaction database 915 on a non-transitory computer readable medium operable for receiving and storing a plurality of sets of interaction data from the user, each set in the plurality of sets representing the user's assessment of an actual interaction with a respective candidate in the initial pool; a modeling engine 930 on a non-transitory computer readable medium operable for developing a machine learning model with the plurality of sets of interaction data, the machine learning model suitable for accepting the plurality of sets of interaction data from the user as an input and functioning to produce a modeled preference data for the user as an output.

In these embodiments, the developing can include
selecting the machine learning model;
preparing the plurality of sets of interaction data for use in training and testing the model, the preparing including splitting the data into training data for training the model, and testing data for testing the model;
training the model with the training data, the training including selecting training variables;
testing the model with the testing data to evaluate the utility of the output; and,
improving the performance of the machine learning model, the improving including adjusting the variables in the training to improve the output of the model.

Consistent with their counterpart methods, the systems can be configured for
creating a modified pool of candidate partners using the output of the model from the input of the plurality of sets of interaction data;
sending the modified pool of candidate partners to the pooling module for use in a next iteration of the system; and,
generating a modeled preference data for the user through the iterative application of the model to optimize the candidate partners for a user interaction.

In some embodiments, the modeling engine trains and tests the model using interaction data from a plurality of users and a respective plurality of sets of interaction data from the plurality of users.

In some embodiments, the pooling module is configured to
exclude the second user from the candidate pool of the first user when the candidate partners for the second user do not include the first user; and,
exclude the first user from the candidate pool of the second user when the candidate partners for the first user do not include the second user.

In some embodiments, the systems further include an assessment module on a non-transitory computer readable medium operable for providing initial match scores to the user for selecting interactions to pursue, the initial match scores including a numerical assessment that provides a measure-of-fit of each candidate to the set of criteria.

In some embodiments, the systems further include a representation module 955 on a non-transitory computer readable medium operable for creating an initial virtual, ideal partner, Pvi, for the user of the network based on initial preference data as input obtained from the user, the creating including
gathering initial preference data from the user of the network, the initial preference data including a set of criteria selected by the user; and,
forming a representation of the Pvi for the user of the network based on the initial preference data from the user.

In some embodiments, the representation module is configured for forming an image of the Pvi for the user based on the initial preference data. In some embodiments, the representation module is configured for forming an image of the Pvi for the user based on the initial preference data. In some embodiments, the representation module is configured for forming an image of the Pvmn, where n ranges from 1 to T, and T is the total number of iterations of the model, the modifying including creating each Pvmn from modeled preference data output by the model at each iteration. In some embodiments, the representation module is configured for forming an image of PvmT.

### EXAMPLES

### Example 1: Creating an Initial Pool Based on Initial Preferences Preconceived by the User

As per the teachings provided herein, interaction data is used to train and test a machine learning model, and the interaction data can be obtained by first generating a simple pooling of personality matches to create an initial pool of potential matching candidates.

Any screening system known to one of skill can be used to form the initial pool of candidates. The system will correlate traits of all users in the community to an initial set of preferences selected by the user forming the candidate pool for interactions. In this example, we showed that ChatGPT, a free machine learning tool, can be used to generate an initial set of criteria for a user of a Roblox gaming platform looking for a playing partner. In this case, ChatGPT selected the initial set of criteria for a playing partner in the Roblox network community. In the alternative, the user could simply enter his own criteria. Regardless, the process can include selecting personality traits to match within the community (fixed data set of candidates), and selecting a pool of possible matching candidates. Interestingly, ChatGPT felt the following personality traits were criteria for matching members for playing together in the closed Roblox gaming community: extroversion, agreeableness, conscientiousness, emotional stability, and openness.

Experimental Method: Use “ChatGPT 4” to write a script for a personality matching program to create a pool of candidate matches within the Roblox gaming community.

```
-- Initialize the player's personality traits
local playerTraits = {
  extroversion = 0,
  agreeableness = 0,
  conscientiousness = 0,
  emotionalStability = 0,
  openness = 0
}
-- Function to calculate the compatibility score between two players
local function calculateCompatibilityScore(player1Traits, player2Traits)
  local score = 0
  -- Calculate the compatibility score based on trait differences
  for trait, value in pairs(player1Traits) do
    score = score + math.abs(value − player2Traits[trait])
  end
  return score
end
-- Function to find the best matching player
local function findBestMatch(player)
  local bestMatch = nil
  local bestScore = math.huge
  -- Iterate through all players to find the best match
  for _, otherPlayer in pairs(game.Players:GetPlayers( )) do
    if otherPlayer ~= player then
      local compatibilityScore = calculateCompatibilityScore(playerTraits,
otherPlayer:GetAttribute(“Traits”))
      if compatibilityScore < bestScore then
        bestMatch = otherPlayer
        bestScore = compatibilityScore
      end
    end
  end
  return bestMatch
end
-- Function to handle player interactions
local function handleInteraction(player1, player2)
  -- Perform interactions between players
  -- This can include chatting, mini-games, or any other gameplay elements
  -- Update player traits based on the interaction
  -- For example, you can increase extroversion if players chat a lot, or increase
conscientiousness if they collaborate in a game
  -- Update the traits in player attributes
  player1:SetAttribute(“Traits”, playerTraits)
  player2:SetAttribute(“Traits”, playerTraits)
end
-- Main game loop
game.Players.PlayerAdded:Connect(function(player)
  player:SetAttribute(“Traits”, playerTraits)
  player.CharacterAdded:Connect(function(character)
    local humanoid = character:WaitForChild(“Humanoid”)
    -- Handle interactions when two players touch each other
    humanoid.Touched:Connect(function(part)
      local otherHumanoid = part.Parent:FindFirstChildOfClass(“Humanoid”)
      if otherHumanoid then
        local otherPlayer = game.Players:GetPlayerFromCharacter(otherHumanoid.Parent)
        if otherPlayer then
          handleInteraction(player, otherPlayer)
        end
      end
    end)
  end)
end)
```

The characteristics chosen for user preferences will have a lot to do with the type of interaction. The characteristic chosen for the Roblox gaming community will be different than the characteristics chosen for employment in a particular field, which will also be different than the characteristics chosen for a platonic friend, which will also be different than the characteristics chosen for a sex partner, which will also be different than the characteristics chosen for a marriage partner, which will also be different than the characteristics chosen for a business partner, which will also be different than the characteristics chosen for an athletic partner, and the like. The characteristics chosen will dictate the type of interaction data that will be obtained to train and test the machine learning model that will model preferences for the user based on initial, preconceived preferences.

### Example 2. Machine Learning Used to Select the Best Potential Matching Candidates for One User in the Match

Machine learning can be used to help a user select the best potential matching candidates for an interaction. Machine learning can be expressed as following 5 steps:
1. Collecting data
2. Preparing the data
3. Training a model: This step involves
   a. choosing the appropriate algorithm and representation of data in the form of the model.
   b. The cleaned data is split into two parts: train and test (proportion depending on the prerequisites); the first part (training data) is used for developing the model.

The second part (test data), is used as a reference.
4. Evaluating the model
5. Improving the performance.

Steps 1 and 2 can include using the process of example 1, for example, to create the initial pool of potential candidates for use in collecting data.

The user of the system will interact with each candidate from the initial pool and create interaction response data. Since each of the candidates will have a personality profile used to create their place in the initial pool of potential candidates, each personality profile can be used to map personality profiles to varying measures of positive and negative responses provided by the user regarding the interactions with the candidates from the initial pool.

Steps 3-5 are then completed. This data can be used to train a machine learning model, evaluate the model, and improve the performance of the model. There are many machine learning models available for use, and the choice of model can be affected by the interaction sought.

Examples of software that may be used by one of skill can include, but are not limited to,

### Free and Open-Source Software

Caffe, ChatGPT (https://openai.com/blog/chatgpt), Deeplearning4j, DeepSpeed, ELKI, Google JAX, Infer.NET, Keras, Kubeflow, LightGBM, Mahout, Mallet, Microsoft Cognitive Toolkit, ML.NET, mlpack, MLFlow, MXNet, Neural Lab, OpenNN, Orange, pandas (software), ROOT (TMVA with ROOT), scikit-learn, Shogun, Spark MLlib, SystemML, TensorFlow, Torch/PyTorch, Weka/MOA, XGBoost, and Yooreeka.
   Proprietary Software with Free and Open-Source Editions
KNIME, and RapidMiner

### Proprietary Software

Amazon Machine Learning, Angoss KnowledgeSTUDIO, Azure Machine Learning, Ayasdi, IBM Watson Studio, Google Cloud Vertex AI, Google Prediction API, IBM SPSS Modeler, KXEN Modeler, LIONsolver, Mathematica, MATLAB, Neural Designer, NeuroSolutions, Oracle Data Mining, Oracle AI Platform Cloud Service, PolyAnalyst, RCASE, SAS Enterprise Miner, SequenceL, Splunk, STATISTICA Data Miner

In addition to the above, there are number of machine learning models that have been patented, and one of interest is U.S. Ser. No. 10/776,712, which is hereby incorporated by reference in it's entirety.

The model selected for the particular application can then be used to iteratively refine and improve the list of potential matching candidates for the user based on the initial pool of potential candidates.

### Example 3. Machine Learning Used to Select the Best Potential Matching Candidates for Each User in the Match

Since the idea is to find the best match for both parties to the relationship, the steps of Example 2 can be applied concurrently to the user and each of the candidates, such that both sides of the potential match are obtaining their best fit within the community.

In such a process, the user and each of the user's candidates will have an initial pool of potential candidates that are selected from the community of users. The machine learning can iteratively identify the best potential matches for the user and each of the user's candidates from the interaction data obtained from the user and each of the user's candidates. In each iteration, the machine learning model is expected to narrow the list of potential candidates for each of the user and the list of potential candidates. As the list of potential candidates narrow, the distinction between this example and Example 2 is that, for a match to occur, each of the users should also be a potential candidate for the other user.

The model can then be used to iteratively refine and improve the list of potential matching candidates for each of the users based on each user's initial pool of potential candidates.

### Example 4. Machine Learning to Design the Best Potential Matching Candidates

The iterative process of Example 2 effectively changes the user's preferences from the initial preferences to a modified set of preferences that, effectively, creates a design for the best potential matches that is a candidate profile inferred from the user's responses to interactions. The iterative approach could lead to candidates from the community that were originally outside of the user's initial pool of potential candidates.

In this example, the user's responses to interactions infer a modified set of preferences that can serve as a design for the best potential matching candidates. The design can be used to screen the community pool once again for a modified pool of candidates using machine learning.

### Example 5. Avatar Creation Using the Systems and Methods Taught Herein

Machine-learning methods of optimizing a match for a user of a matching network is provided, along with systems for practicing the methods. The methods include comparing a modeled virtual, ideal partner to a live candidate partner. The methods include all, or a subset of, the following limitations:
1. creating an initial virtual, ideal partner, Pvi, for the user of the network based on initial preference data as input obtained from the user, the creating including
   a. gathering initial preference data from the user of the network, the initial preference data including a set of criteria selected by the user;
   b. forming a representation of the Pvi for the user of the network based on the initial preference data from the user;
2. assembling an initial pool of candidate partners for the use from within the matching network based on the initial preference data from the user, each candidate in the initial pool meeting the set of criteria within an acceptable deviation threshold used by the method to select each candidate in the initial pool;
3. providing initial match scores to the user for selecting interactions to pursue, the initial match scores including a numerical assessment that measures the fit of each candidate to the set of criteria;
4. obtaining a plurality of sets of interaction data from the user, each set in the plurality of sets representing the user's assessment of an actual interaction with a respective candidate in the initial pool;
5. developing a machine learning model with the plurality of sets of interaction data, the machine learning model suitable for accepting the plurality of sets of interaction data from the user as an input and functioning to produce a modeled preference data for the user as an output, the developing including
   a. selecting the machine learning model;
   b. preparing the plurality of sets of interaction data for use in training the model, the preparing including splitting the data into training data for training the model, and testing data for testing the model;
   c. training the model with the training data, the developing including selecting training variables;
   d. testing the model with the testing data to evaluate the utility of the output;
   e. improving the performance of the machine learning model, the improving including adjusting the variables in the training process to improve the output of the model; and,
   f. iterating the model stepwise from Pvi to a modeled, virtual ideal partner, Pvmn, where n ranges from 1 to T, and T is the total number of iterations of the model, the modifying including creating each Pvmn from modeled preference data output by the model at each iteration;
6. modifying the pool of candidate partners at each iteration using the modeled preference data for each Pvmn; and,
7. forming a representation of PvmT for the user of the network based on the modeled preference data from the user.

Machine learning systems for modeling preference data are also provided, of course, to optimize candidate partners of interest for a user interaction. As these are computerized systems, they include a processor; and a memory. In these systems, the memory can include all, or a subset of, the following limitations:
a preference module on a non-transitory computer readable medium operable for receiving and storing initial preference data from a user of a networking community;
a pooling module on a non-transitory computer readable medium operable for assembling a pool of candidate partners for the user from within the matching network based on the initial preference data from the user, each candidate in the pool meeting the set of criteria within an acceptable deviation threshold used by the method to select each candidate in the pool;
an interaction database on a non-transitory computer readable medium operable for receiving and storing a plurality of sets of interaction data from the user, each set in the plurality of sets representing the user's assessment of an actual interaction with a respective candidate in the initial pool;
a modeling engine on a non-transitory computer readable medium operable for developing a machine learning model with the plurality of sets of interaction data, the machine learning model suitable for accepting the plurality of sets of interaction data from the user as an input and functioning to produce a modeled preference data for the user as an output, the developing including
   selecting the machine learning model;
   preparing the plurality of sets of interaction data for use in training and testing the model, the preparing including splitting the data into training data for training the model, and testing data for testing the model;
   training the model with the training data, the training including selecting training variables;
   testing the model with the testing data to evaluate the utility of the output;
   improving the performance of the machine learning model, the improving including adjusting the variables in the training to improve the output of the model;
wherein, the system is configured for
   creating a modified pool of candidate partners using the output of the model from the input of the plurality of sets of interaction data;
   sending the modified pool of candidate partners to the pooling module for use in a next iteration of the system; and,
   generating a modeled preference data for the user through the iterative application of the model to optimize the candidate partners for a user interaction;
and,
the system further including a representation module on a non-transitory computer readable medium operable for creating an initial virtual, ideal partner, Pvi, for the user of the network based on initial preference data as input obtained from the user, the creating including
   gathering initial preference data from the user of the network, the initial preference data including a set of criteria selected by the user; and,
   forming a representation of the Pvi for the user of the network based on the initial preference data from the user.

The systems can create avatars with any avatar creation technology known to the person of ordinary skill. As such, the systems can be configured with an avatar module, the avatar module instructing the processor to create avatars designed or selected by users of the system through evolving user inputs.

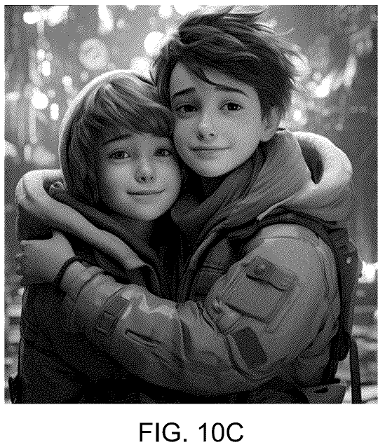

FIGS. 10A-10C illustrate avatar types, according to some embodiments. In FIG. 10A, illustrates simple avatar types representing upper body, head and neck, hair style and length, facial hair, facial structure, and the like, are all presented in simple representations that can be used as a tool to develop an evolving avatar for the user or for a user's desired partner. These can start with simple “people pattern” or “people vector sets” and be used to evolve into more desirable avatars over time through the use of evolving user input that can be derived from evolving user experiences. FIG. 10B expands into simple avatar body types that, like the upper body, head-and-neck of FIG. 10A, can be used to start the avatar building process. The body types can also evolve due to user input, which can be from user experiences, and used as a tool to develop an evolving avatar for the user or for a user's desired partner. As shown in FIG. 10C, the avatar development can be quite detailed and representative, the level of detail provided being subjective the choice of avatar building tools. In some embodiments, the avatars can be quite life-like, using tools now used in cinematography to create avatars the do a great job of resembling an actual human.

This example illustrates the ability of the systems and methods taught herein to use inputs from user experiences to create and evolve avatars that can be used to better represent the user and, in many embodiments, better represent the user's desired partner as the avatar evolves from the user's actual experiences and interactions with people in the real world, the systems and methods used as tools to evolve the avatars over time.

Regardless of the information presented, some embodiments teach the concept of a system for identifying a mutual interest in a relationship or interaction between users of the systems taught herein, whether personal or business, or other, in nature. The system can provide a powerful and unique experience not available elsewhere and, in some embodiments, it can process multimedia in the form of text, images, video, and sound in performing it's functions and operations.

We claim:

1. A machine-learning method of optimizing a match for a user of a matching network by comparing a modeled virtual, ideal partner to a live candidate partner, the method comprising:
creating an initial virtual, ideal partner, Pvi, for the user of the network based on initial preference data as input obtained from the user, the creating including
gathering initial preference data from the user of the network, the initial preference data including a set of criteria selected by the user;
forming a representation of the Pvi for the user of the network based on the initial preference data from the user;
assembling an initial pool of candidate partners for the use from within the matching network based on the initial preference data from the user, each candidate in the initial pool meeting the set of criteria within an acceptable deviation threshold used by the method to select each candidate in the initial pool;
providing initial match scores to the user for selecting interactions to pursue, the initial match scores including a numerical assessment that measures the fit of each candidate to the set of criteria;
obtaining a plurality of sets of interaction data from the user, each set in the plurality of sets representing the user's assessment of an actual interaction with a respective candidate in the initial pool;
developing a machine learning model with the plurality of sets of interaction data, the machine learning model suitable for accepting the plurality of sets of interaction data from the user as an input and functioning to produce a modeled preference data for the user as an output, the developing including
selecting the machine learning model;
preparing the plurality of sets of interaction data for use in training the model, the preparing including splitting the data into training data for training the model, and testing data for testing the model;
training the model with the training data, the developing including selecting training variables;
testing the model with the testing data to evaluate the utility of the output; and,
improving the performance of the machine learning model, the improving including adjusting the variables in the training process to improve the output of the model;
iterating the model stepwise from Pvi to a modeled, virtual ideal partner, Pvmn, where n ranges from 1 to T, and T is the total number of iterations of the model, the modifying including creating each Pvmn from modeled preference data output by the model at each iteration;
modifying the pool of candidate partners at each iteration using the modeled preference data for each Pvmn; and,
forming a representation of PvmT for the user of the network based on the modeled preference data from the user.

2. The method of claim 1, wherein the providing of the the initial match scores is limited to candidates that meet an acceptable deviation selected by the user.

3. The method of claim 1, wherein the representation of Pvi is a data representation.

4. The method of claim 1, wherein the representation of Pvi is a graphical representation that includes an image of Pvi.

5. The method of claim 1, wherein the representation of PvmT is a data representation.

6. The method of claim 1, wherein the representation of PvmT is a graphical representation that includes an image of PvmT.

7. The method of claim 1, wherein the method includes forming a representation of each Pvmn for the user of the network at each iteration, the representation including an image of each Pvmn.

8. A machine learning system for modeling preference data to optimize candidate partners of interest for a user interaction, comprising a processor; and a memory, the memory comprising:
a preference module on a non-transitory computer readable medium operable for receiving and storing initial preference data from a user of a networking community;
a pooling module on a non-transitory computer readable medium operable for assembling a pool of candidate partners for the user from within the matching network based on the initial preference data from the user, each candidate in the pool meeting the set of criteria within an acceptable deviation threshold used by the method to select each candidate in the pool;
an interaction database on a non-transitory computer readable medium operable for receiving and storing a plurality of sets of interaction data from the user, each set in the plurality of sets representing the user's assessment of an actual interaction with a respective candidate in the initial pool;
a modeling engine on a non-transitory computer readable medium operable for developing a machine learning model with the plurality of sets of interaction data, the machine learning model suitable for accepting the plurality of sets of interaction data from the user as an input and functioning to produce a modeled preference data for the user as an output, the developing including
selecting the machine learning model;
preparing the plurality of sets of interaction data for use in training and testing the model, the preparing including splitting the data into training data for training the model, and testing data for testing the model;
training the model with the training data, the training including selecting training variables;
testing the model with the testing data to evaluate the utility of the output;
improving the performance of the machine learning model, the improving including adjusting the variables in the training to improve the output of the model;
wherein, the system is configured for
creating a modified pool of candidate partners using the output of the model from the input of the plurality of sets of interaction data;
sending the modified pool of candidate partners to the pooling module for use in a next iteration of the system; and,
generating a modeled preference data for the user through the iterative application of the model to optimize the candidate partners for a user interaction;
and,
the system further including a representation module on a non-transitory computer readable medium operable for creating an initial virtual, ideal partner, Pvi, for the user of the network based on initial preference data as input obtained from the user, the creating including
gathering initial preference data from the user of the network, the initial preference data including a set of criteria selected by the user; and,
forming a representation of the Pvi for the user of the network based on the initial preference data from the user.

9. The system of claim 8, wherein the modeling engine trains and tests the model using interaction data from a plurality of users and a respective plurality of sets of interaction data from the plurality of users.

10. The system of claim 9, wherein the pooling module is configured to function such that
exclude the second user from the candidate pool of the first user when the candidate partners for the second user do not include the first user; and,
exclude the first user from the candidate pool of the second user when the candidate partners for the first user do not include the second user.

11. The system of claim 8, further including an assessment module on a non-transitory computer readable medium operable for providing initial match scores to the user for selecting interactions to pursue, the initial match scores including a numerical assessment that provides a measure-of-fit of each candidate to the set of criteria.

12. The system of claim 8 further comprising an avatar module, the avatar module instructing the processor to create avatars designed or selected by users of the system.

13. The system of claim 8, wherein the representation module is configured for forming an image of the Pvi for the user based on the initial preference data.

14. The system of claim 8, wherein the representation module is configured for forming an image of the Pvi for the user based on the initial preference data.

15. The system of claim 8, wherein the representation module is configured for forming an image of the Pvmn, where n ranges from 1 to T, and T is the total number of iterations of the model, the modifying including creating each Pvmn from modeled preference data output by the model at each iteration.

16. The system of claim 15, wherein the representation module is configured for forming an image of PvmT.

17. A system for identifying a mutual interest between a first user and a second user within a shared user environment, the system comprising:
a processor; and,
a memory on a non-transitory computer readable medium, the memory including
a registration module on a non-transitory computer readable medium, the registration module operable for receiving user information and assigning a first anonymous identifier to the first user and a second anonymous identifier to the second user for use in the shared user environment;
a location engine on a non-transitory computer readable medium, the location engine operable for identifying the location of the first user and the location of the second user within the shared user environment;
an assessment module on a non-transitory computer readable medium, the assessment module operable for the first user to identify and assess the second user, and the second user to identify and assess the first user;
a matching module on a non-transitory computer readable medium, the matching module operable for the first user to identify a match with the second user and the second user to identify the match with the first user, the matching module notifying the first user and the second user of the match;
a data exchange module on a non-transitory computer readable medium, the data exchange module operable for the first user to communicate with the second user upon the identification of the match, and the second user to communicate with the first user upon the identification of the match; and,
a shared user database on a non-transitory computer readable medium, the shared user database operable for storing personal information, location information, and the anonymous identifiers of n users, in which n is a number of users ranging from 2 users to any number of users, of which at least the first user and the second user are in the shared user environment;
wherein, each of the first user and the second user are notified of the match by the matching module and have the option to communicate with the other user through the data exchange module;
and,
the system further including a representation module on a non-transitory computer readable medium operable for creating an initial virtual, ideal partner, Pvi, for the user of the network based on initial preference data as input obtained from the user, the creating including
gathering initial preference data from the user of the network, the initial preference data including a set of criteria selected by the user; and,
forming a representation of the Pvi for the user of the network based on the initial preference data from the user.

18. The system of claim 17 further comprising an advertising module, the advertising module instructing the processor to identify particular user location data and activity tracking data, and to target advertising to those particular users.

19. The system of claim 17 further comprising a feedback module, the feedback module instructing the processor to receive and record feedback by one or more users of the system.

20. The system of claim 17 further comprising an avatar module, the avatar module instructing the processor to create avatars designed or selected by users of the system.

21. The system of claim 17 further comprising a ratings module, the ratings module instructing the processor to measure or assess relative levels of interest in other users.

22. The system of claim 17 further comprising a governing module, the governing module instructing the processor to set a governing level of interest in a user's database before the system recognizes a mutual interest in a meeting.

23. The system of claim 17 further comprising a distribution module, the distribution module instructing the processor to help users locate nodes of users of the system.

24. The system of claim 17 further comprising an intelligence module, the intelligence module instructing the processor to target and compile the select logistics of users of the system.

25. The system of claim 17 further comprising a mood module, the mood module instructing the processor to show the mood of one or more users of the system to other users of the system.

26. A method for a second user to identify a mutual interest with a first user within a shared user environment using the system of claim 1, the method comprising:
using the system of claim 17;
registering as the second user in the shared user database through the registration module and obtaining the second anonymous identifier as a persona in the shared user environment;
entering the shared user environment and allowing the location engine to establish a second location of the second anonymous identifier in the shared user environment, the location of the second identifier accessible by the n users in the shared user environment;
identifying the first user in the shared user environment with the assessment module by identifying a first location of the first anonymous identifier through the location module;
assessing the first user with the assessment module;
receiving the notice of the match with the second user from the matching module; and,
choosing whether to communicate with the second user through the data exchange module;
wherein, each of the first user and the second user are notified of the match by the matching module and have the option to communicate with each other through the data exchange module.
